(19) United States
(12) Patent Application Publication
(10) Pub. No.: US 2005/0127321 A1
(43) Pub. Date: Jun. 16, 2005

(54) Compositions containing lactone compatibilizers

(76) Inventors: Paul Joseph Fagan, Wilmington, DE (US); Barbara Haviland Minor, Elkton, MD (US); Steven W. Shuey, Landenberg, PA (US); Walter Mahler, Wilmington, DE (US)

Correspondence Address: E I DU PONT DE NEMOURS AND COMPANY;LEGAL PATENT RECORDS CENTER, BARLEY MILL PLAZA 25/1128, 4417 LANCASTER PIKE, WILMINGTON, DE, 19805, US

(21) Appl. No.: 10/965,322

(22) Filed: Oct. 14, 2004

Related U.S. Application Data
(60) Provisional application No. 60/511,881, filed on Oct. 15, 2003.

(51) Int. Cl. C09K 5/00

(52) U.S. Cl. 252/68

(57) ABSTRACT

The present invention relates to compositions that are useful for compatibilizing a conventional compression refrigeration lubricant and a hydrofluorocarbon and/or hydrochlorofluorocarbon refrigerant in a compression refrigeration or air conditioning system. Additionally, these compositions promote efficient return of lubricant from the non-compressor zones to the compressor zones of refrigeration and air conditioning systems.

### CROSS REFERENCE(S) TO RELATED APPLICATION(S)

This application claims the priority benefit of U.S. Provisional Application 60/511,881, filed Oct. 15, 2003.

### BACKGROUND OF THE INVENTION

1. Field of the Invention

The present invention relates to compositions comprising fluorocarbon refrigerant, conventional, compression refrigeration lubricant and a lactone compatibilizer that compatibilizes said fluorocarbon refrigerant and said lubricant. The present invention also relates to compositions for use with fluorocarbon refrigerant comprising compression refrigeration lubricant and a lactone compatibilizer and methods for producing refrigeration and heat, lubricating a compressor, returning oil from non-compressor zone to compressor zone, and solubilizing fluorocarbon refrigerant and lubricant.

2. Description of Related Art

Over the course of the last twenty (20) years it has been debated whether the release of chlorofluorocarbons into the atmosphere has effected the stratospheric ozone layer. As a result of this debate and international treaties, the refrigeration and air-conditioning industries have been weaning themselves from the use and production of certain chlorofluorocarbons (CFCs) and hydrochlorofluorocarbons (HCFCs). Presently, the industries are transitioning towards the use of hydrofluorocarbons (HFCs) having zero ozone depletion potential. Notably, this transition to HFCs necessitated the advent of a new class of lubricants because of the immiscibility of conventional lubricants, such as mineral oil, poly alpha-olefin and alkylbenzene with HFC refrigerants.

The new class of lubricants includes polyalkylene glycols (PAGs) and polyol esters (POEs) lubricants. While the PAG and POE lubricants have suitable lubricant properties, they are extremely hygroscopic and can absorb several thousand ppm (parts per million) of water on exposure to moist air. This absorbed water leads to undesirable formation of acids that cause corrosion of refrigeration systems and formation of intractable sludges. In comparison, conventional refrigeration lubricants are considerably less hygroscopic and have low solubility, less than 100 ppm for water. Further, PAGs and POEs are considerably more expensive than conventional refrigeration lubricants—typically on the order of three to six times more. PAGs and POEs have also been found to have unfavorable electrical insulating properties.

Accordingly, there existed a need and an opportunity to resolve this solubility problem so that the refrigeration industry could utilize conventional mineral oil and alkylbenzene lubricants with HFC-based refrigerants. Another need and opportunity also existed when the industry began transitioning towards the use of HCFC-based refrigerants as a replacement for pure CFC refrigerants. This need became apparent due to the diminished solubility of HCFCs in mineral oil, which forced the industry to incur an additional expense of changing the lubricant to an alkylbenzene to achieve adequate lubricating and cooling performance.

For the last ten years the refrigeration and air-conditioning industries have been struggling with these long-felt but unsolved needs, finally, the present invention satisfies the pressing needs of these industries. While numerous attempts have been made to use conventional non-polar lubricants with polar hydrofluorocarbon refrigerants, the lack of solubility of the polar refrigerant in the non-polar conventional lubricant generally results in a highly viscous lubricant in the non-compressor zones, which unfortunately results in insufficient lubricant return to the compressor. When the non-polar conventional lubricant and the polar refrigerant naturally escape the compressor and enter the non-compressor zones, phase separation/insolubility of the lubricant and the refrigerant occurs. This phase separation contributes to the highly viscous lubricant remaining in the non-compressor zone, whilst the refrigerant continues its path throughout the refrigeration system. The insolubility and highly viscous nature of the lubricant leaves the lubricant stranded in the non-compressor zones, which leads to an undesirable accumulation of lubricant in the non-compressor zones. This accumulation of lubricant and the lack of return of the lubricant to the compressor zone eventually starves the compressor of lubricant and results in the compressor failure, such as overheating and seizing. Such stranded lubricant may also decrease the efficiency of the refrigeration system by interfering with heat transfer, due to thick lubricant films deposited on interior surfaces of the heat exchangers (e.g. condenser and evaporator). Further, during cold compressor starts, insoluble refrigerant and lubricant may cause compressor seizure due to poor lubrication and foaming of the lubricant.

For the foregoing reasons, there is a well-recognized need in the refrigeration and air-conditioning industries for a compatibilizer that compatibilizes a polar fluorocarbon refrigerant and a non-polar conventional lubricant in a compression refrigeration system, and promotes efficient return of lubricant to the compressor.

### BRIEF SUMMARY OF THE INVENTION

A composition has been discovered for use in a compression refrigeration and air conditioning system, said composition comprising:
(a) at least one fluorocarbon refrigerant selected from the group consisting of hydrofluorocarbons, hydrochlorofluorocarbons, perfluorocarbons, and hydrofluorocarbon ethers; and
(b) at least one compatibilizer selected from the group consisting of compounds represented by formula I, II, and III: 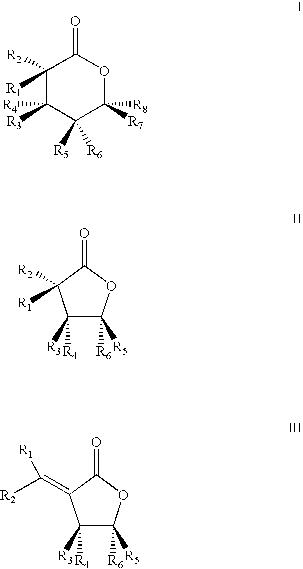
   wherein, R₁ through R₈ are independently selected from the group consisting of hydrogen, linear, branched, cyclic, bicyclic, saturated and unsaturated hydrocarbyl radicals; the carbon to ester functional group carbonyl oxygen ratio is from about 7 to about 15; and the molecular weight is from about 100 to about 300 atomic mass units.

The above composition may optionally further comprise at least one lubricant selected from the group consisting of paraffins, napthenes, aromatics and poly-alpha-olefins.

A composition has also been discovered for use in compression refrigeration and air conditioning system comprising:
(a) at least one lubricant selected from the group consisting of paraffins, napthenes, aromatics, and poly-alpha-olefins; and
(b) at least one compatibilizer selected from the group consisting of compounds represented by formula I, II, and III: 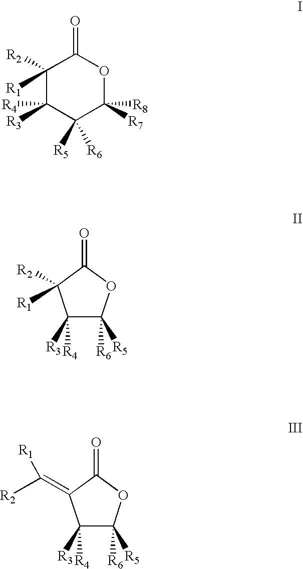
   wherein, R₁ through R₈ are independently selected from hydrogen, linear, branched, cyclic, bicyclic, saturated and unsaturated hydrocarbyl radicals; and wherein the carbon to ester functional group carbonyl oxygen ratio is from about 7 to about 15 and the molecular weight is from about 100 to about 300 atomic mass units.

The compositions of the present invention may optionally contain at least one additional compound selected from the group consisting of: polyoxyalkylene glycol ethers, amides, ketones, nitriles, chlorocarbons, aryl ethers, 1,1,1-trifluoroalkanes, and fluoroethers.

The compositions of the present invention may optionally contain at least one hydrocarbon selected from the group consisting of: decanes, undecanes, dodecanes, tridecanes, tetradecanes, pentadecanes and hexadecanes.

Additionally, it has been discovered that the aforementioned compositions are useful in processes for producing refrigeration and heat, and returning lubricant from a non-compressor zone to a compressor zone of a compression refrigeration or air conditioning system.

Finally, it has been discovered that the aforementioned compositions are useful in methods for delivering a compatibilizer to a compression refrigeration or air conditioning system; for providing miscibility and/or solubility of a fluorocarbon refrigerant with a lubricant selected from the group consisting of paraffins, napthenes, aromatics and poly-alpha-olefins; and for lubricating a compressor in a compression refrigeration or air conditioning system.

The present invention meets a need in the refrigeration and air conditioning industries for a means of utilizing conventional refrigeration lubricants with fluorocarbon refrigerants.

### BRIEF DESCRIPTION OF THE DRAWING

The present invention is better understood with reference to the following figure, wherein:

FIG. 1. Experimental setup for measuring phase separation temperatures of refrigerant with lubricants and compatibilizers (not drawn to scale). Apparatus was constructed of glass with Teflon® stopcock vacuum valves.

### DETAILED DESCRIPTION OF THE INVENTION

The present inventors discovered that using an effective amount of the present lactone compatibilizers in conventional compression refrigeration lubricants results in efficient return of lubricant from non-compressor zones to a compressor zone in a compression refrigeration system. The compatibilizers travel throughout a compression refrigeration system mixed with refrigerant and with lubricant that escapes the compressor. It is believed that use of compatibilizers results in the decrease of the viscosity of lubricant in the coldest portions of compression refrigeration systems, such as an evaporator, thereby enabling return of the lubricant from the evaporator to the compressor. The inventors discovered that the viscosity of lubricant in the coldest sections of compression refrigeration systems is reduced upon use of the present compatibilizers. This reduction in lubricant viscosity is due to an increase in solubility of fluorocarbon refrigerants in lubricant containing the compatibilizers. Through control of the ratio of carbon to carbonyl polar groups in the compatibilizer, the inventors discovered that the polar group-containing compatibilizer could surprisingly be caused to remain miscible with the essentially non-polar lubricants in the coldest sections of compression refrigeration system and simultaneously increase the solubility of fluorocarbon refrigerant in the lubricant. Without wishing to be bound by theory, the polar functional groups in the present compatibilizers are attracted to the relatively polar fluorocarbon refrigerant while the hydrocarbon portion of the compatibilizer is miscible with the relatively low polarity lubricant. The result upon use of the present compatibilizers in conventional lubricants is an increase in the solubility of fluorocarbon refrigerants in lubricant containing an effective amount of compatibilizer. This increased solubility of the relatively non-viscous fluorocarbon refrigerant in conventional lubricants leads to lowering of the viscosity of the lubricant, and results in efficient return of lubricant from non-compressor zones to a compressor zone in a compression refrigeration system. Reducing the amount of lubricant in the evaporator zone also improves heat transfer of the refrigerant and thus improves refrigerating capacity and efficiency of a system. Thus, the present compatibilizers allow for the use of relatively polar fluorocarbon refrigerants, such as hydrofluorocarbons and hydrochlorofluorocarbons, with relatively non-polar conventional lubricants; mixtures which are normally immiscible and previously thought to be not useful together as refrigerant compositions in compression refrigeration systems.

The result of increased solubility of fluorocarbon refrigerants in conventional lubricants further allows liquid fluorocarbon refrigerant to dissolve and carry stranded lubricant out of the condenser, improving both lubricant return and heat transfer in the condenser and resulting in improved capacity and efficiency of the refrigeration system.

In the present compositions comprising lubricant and lactone compatibilizer, from about 1 to about 50 weight percent, preferably from about 6 to about 45 weight percent, and most preferably from about 10 to about 40 weight percent of the combined lubricant and compatibilizer composition is compatibilizer. In terms of weight ratios, in the present compositions comprising lubricant and compatibilizer, the weight ratio of lubricant to compatibilizer is from about 99:1 to about 1:1, preferably from about 15.7:1 to about 1.2:1, and most preferably from about 9:1 to about 1.5:1. Compatibilizer may be charged to a compression refrigeration or air conditioning system as a combination of compatibilizer and fluorocarbon refrigerant. When charging a compression refrigeration system with the present compatibilizer and fluorocarbon refrigerant compositions, to deliver an amount of compatibilizer such that the aforementioned relative amounts of compatibilizer and lubricant are satisfied, the compatibilizer and fluorocarbon refrigerant composition will typically comprise from about 0.1 to about 40 weight percent, preferably from about 0.2 to about 20 weight percent, and most preferably from about 0.3 to about 10 weight percent compatibilizer in the combined compatibilizer and fluorocarbon refrigerant composition.

In compression refrigeration or air conditioning systems containing the present compositions from about 1 to about 70 weight percent, preferably from about 10 to about 60 weight percent, of the composition is lubricant and compatibilizer. Compatibilizer concentrations greater than about 50 weight percent of the combined lubricant and compatibilizer composition are typically not needed to obtain acceptable lubricant return from non-compressor zones to a compressor zone. Compatibilizer concentrations greater than about 50 weight percent of the combined lubricant and compatibilizer composition can negatively influence the viscosity of the lubricant, which can lead to inadequate lubrication and stress on, or mechanical failure of, the compressor.

Further, compatibilizer concentrations higher than about 50 weight percent of the combined lubricant and compatibilizer composition can negatively influence the refrigeration capacity and performance of a refrigerant composition in a compression refrigeration system. An effective amount of compatibilizer in the present compositions leads to fluorocarbon refrigerant and lubricant becoming solubilized to the extent that adequate return of lubricant in a compression refrigeration system from non-compressor zones (e.g. evaporator or condenser) to the compressor zone is obtained.

Fluorocarbon refrigerants of the present invention contain at least one carbon atom and one fluorine atom. Of particular utility are fluorocarbons having 1-6 carbon atoms containing at least one fluorine atom, optionally containing chlorine and oxygen atoms, and having a normal boiling point of from −90° C. to 80° C. These fluorocarbons may be represented by the general formula C_{w}F_{2w+2-x-y}HₓCl_{y}O_{z}, wherein w is 1-6, x is 0-9, y is 0-3, and z is 0-2. Preferred of the fluorocarbons are those in which w is 1-6, x is 1-5, y is 0-1, and z is 0-1. The present invention is particularly useful with hydrofluorocarbon and hydrochlorofluorocarbon-based refrigerants. Fluorocarbon refrigerants are commercial products available from a number of sources such as E. I. du Pont de Nemours & Co., Fluoroproducts, Wilmington, Del., 19898, USA, or are available from custom chemical synthesis companies such as PCR Inc., P.O. Box 1466, Gainesville, Fla., 32602, USA, and additionally by synthetic processes disclosed in art such as The Journal of Fluorine Chemistry, or Chemistry of Organic Fluorine Compounds, edited by Milos Hudlicky, published by The MacMillan Company, New York, N.Y., 1962. Representative fluorocarbons include but are not limited to: CHClF₂ (HCFC-22), CHF₃ (HFC-23), CH₂F₂ (HFC-32), CH₃F (HFC-41), CF₃CF₃(FC-116), CHClFCF₃ (HCFC-124), CHF₂CF₃ (HFC-125), CH₂ClCF₃ (HCFC-133a), CHF₂CHF₂ (HFC-134), CH₂FCF₃ (HFC-134a), CClF₂CH₃ (HCFC-142b), CHF₂CH₂F (HFC-143), CF₃CH₃ (HFC-143a), CHF₂CH₃ (HFC-152a), CHF₂CF₂CF₃ (HFC-227ca), CF₃CFHCF₃ (HFC-227ea), (HFC-236ca), CH₂FCF₂CF₃ (HFC-236cb), CHF₂CHFCF₃ (HFC-236ea), CF₃CH₂CF₃ (HFC-236fa), CH₂FCF₂CHF₂ (HFC-245ca), CH₃CF₂CF₃ (HFC-245cb), CHF₂CHFCHF₂ (HFC-245ea), CH₂FCHFCF₃ (HFC-245eb), CHF₂CH₂CF₃ (HFC-245fa), CH₂FCF₂CH₂F (HFC-254ca), CH₂CF₂CHF₂ (HFC-254cb), CH₂FCHFCHF₂ (HFC-254ea), CH₃CHFCF₃ (HFC-254eb), CHF₂CH₂CHF₂ (HFC-254fa), CH₂FCH₂CF₃ (HFC-254fb), CH₃CF₂CH₃ (HFC-272ca), CH₃CHFCH₂F (HFC-272ea), CH₂FCH₂CH₂F (HFC-272fa), CH₃CH₂CF₂H(HFC-272fb), CH₃CHFCH₃ (HFC-281ea), CH₃CH₂CH₂F (HFC-281fa), CHF₂CF₂CF₂CF₂H(HFC-338 pcc), CF₃CHFCHFCF₂CF₃ (HFC43-10mee), C₄F₉OCH₃, and C₄F₉OC₂H₅.

The present invention is particularly useful with the hydrofluorocarbon and hydrochlorofluorocarbon-based refrigerants, such as, CHClF₂ (HCFC-22), CHF₃ (HFC-23), CH₂F₂ (HFC-32), CHClFCF₃ (HCFC-124), CHF₂CF₃ (HFC-125), CHF₂CHF₂ (HFC-134), CH₂FCF₃ (HFC-134a), CF₃CH₃ (HFC-143a), CHF₂CH₃ (HFC-152a), CHF₂CF₂CF₃ (HFC-227ca), CF₃CFHCF₃ (HFC-227ea), CF₃CH₂CF₃ (HFC-236fa), CHF₂CH₂CF₃ (HFC-245fa), CHF₂CF₂CF₂CF₂H(HFC-338 pcc), CF₃CHFCHFCF₂CF₃ (HFC43-10mee); and refrigerant blend compositions, such as, HCFC-22/HFC-152a/HCFC-124 (known by the ASHRAE designations, R-401A, R401B, and R401C), HFC-125/HFC-143a/HFC-134a (known by the ASHRAE designation, R404A), HFC-32/HFC-125/HFC-134a (known by ASHRAE designations, R407A, R-407B, and R407C), HCFC-22/HFC-143a/HFC-125 (known by the ASHRAE designation, R-408A), HCFC-22/HCFC-124/HCFC-142b (known by the ASHRAE designation: R409A), HFC-32/HFC-125 (R410A), and HFC-125/HFC-143a (known by the ASHRAE designation: R-507).

The fluorocarbon refrigerants of the present invention may optionally further comprise up to 10 weight percent of dimethyl ether, or at least one C₃ to C₅ hydrocarbon, e.g., propane, propylene, cyclopropane, n-butane, isobutane, n-pentane, cyclopentane and neopentane (2,2-dimethylpropane). Examples of fluorocarbon refrigerant compositions containing such C₃ to C₅ hydrocarbons are: HCFC-22/HFC-125/propane (known by the ASHRAE designation, R-402A and R402B), HCFC-22/octafluoropropane/propane (known by the ASHRAE designation, R-403A and R403B), HCFC-22/HCFC-124/HCFC-142b/isobutane (known by the ASHRAE designation: R-414A and R414B), HFC-125/HFC-134a/n-butane (known by the ASHRAE designation: R417A), HFC-125/HFC-134a/dimethyl ether (known by the ASHRAE designation: R-419A), and HFC-125/HFC-134a/isobutane (known by the ASHRAE designation: R422A).

Lubricants of the present invention are those conventionally used in compression refrigeration system utilizing chlorofluorocarbon and/or hydrochlorofluorocarbon refrigerants. Such lubricants and their properties are discussed in the 1990 ASHRAE Handbook, Refrigeration Systems and Applications, chapter 8, titled “Lubricants in Refrigeration Systems”, pages 8.1 through 8.21, herein incorporated by reference. Lubricants are selected by considering a given compressor's requirements and the environment to which the lubricant will be exposed. Lubricants used in the combinations of the present invention preferably have a kinematic viscosity of at least about 15 centistokes at 40° C. and are commonly known as “mineral oils” in the field of compression refrigeration lubrication. Mineral oils comprise paraffins (i.e. straight-chain and branched-carbon-chain, saturated hydrocarbons), naphthenes (i.e. cyclic paraffins) and aromatics (i.e. unsaturated, cyclic hydrocarbons containing one or more rings characterized by alternating double bonds). Lubricants of the present invention further comprise those commonly known as “synthetic oils” in the field of compression refrigeration lubrication. Synthetic oils comprise alkylaryls (i.e. linear and branched alkyl alkylbenzenes), synthetic paraffins and napthenes, and poly alpha-olefins. Representative conventional lubricants that may be used in the compositions of the present invention are the commercially available BVM 100 N (paraffinic mineral oil sold by BVA Oils), Suniso® 3GS (napthenic mineral oil sold by Crompton Co.), Sontex® 372LT (napthenic mineral oil sold by Pennzoil), Calumet® RO-30 (napthenic mineral oil sold by Calument Lubricants), Zerol® 75 and Zerol® 150 (linear alkylbenzenes sold by Shrieve Chemicals) and HAB 22 (branched alkylbenzene sold by Nippon Oil).

The compatibilizers of the present invention comprise lactones represented by formulas I, II, and III:

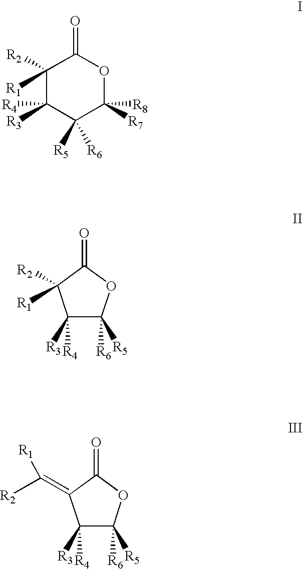

These lactones contain the functional group —CO₂— in a ring of six (I), or preferably five atoms (II), wherein for formulas I and I₁, R₁ through R₈ are independently selected from hydrogen, linear, branched, cyclic, bicyclic, saturated and unsaturated hydrocarbyl radicals. Each R₁ through R₈ may be connected forming a ring with another R₁ through R₈. The lactone may have an exocyclic alkylidene group as in formula III, wherein R₁ through R₆ are independently selected from hydrogen, linear, branched, cyclic, bicyclic, saturated and unsaturated hydrocarbyl radicals. Each R₁ though R₆ may be connected forming a ring with another R₁ through R₆. The lactone compatibilizers of the present invention have a carbon to ester functional group carbonyl oxygen ratio from about 7 to about 15, preferred from about 9 to about 13, and most preferred from about 10 to about 12. Said lactone compatibilizers also have a molecular weight range of from about 100 to about 300 atomic mass units, preferred from about 150 to about 250 atomic mass units, and most preferred from about 175 to about 225 atomic mass units. Representative lactone compatibilizers include the compounds listed in the Table I below.

TABLE I

| | | | | Carbon to Ester |
|---|---|---|---|---|
| | | Molecular | Molecular | Carbonyl |
| Compatibilizer | Molecular Structure | Formula | Weight (amu) | Oxygen Ratio |
| (E,Z)-3-ethylidene-5- methyl-dihydro-furan-2-one | 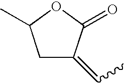 | C₇H₁₀O₂ | 126 | 7 |
| (E,Z)-3-propylidene-5- methyl-dihydro-furan-2-one | 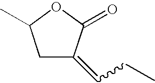 | C₆H₁₂O₂ | 140 | 8 |
| (E,Z)-3-butylidene-5- methyl-dihydro-furan-2-one | 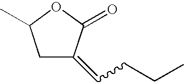 | C₉H₁₄O₂ | 154 | 9 |
| (E,Z)-3-pentylidene-5- methyl-dihydro-furan-2-one | 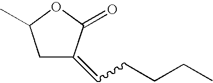 | C₁₀H₁₆O₂ | 168 | 10 |
| (E,Z)-3-Hexylidene-5- methyl-dihydro-furan-2-one | 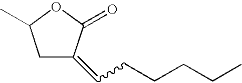 | C₁₁H₁₈O₂ | 182 | 11 |
| (E,Z)-3-Heptylidene-5- methyl-dihydro-furan-2-one | 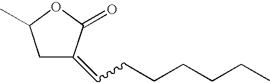 | C₁₂H₂₀O₂ | 196 | 12 |
| (E,Z)-3-octylidene-5- methyl-dihydro-furan-2-one | 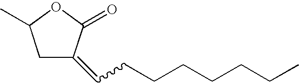 | C₁₃H₂₂O₂ | 210 | 13 |
| (E,Z)-3-nonylidene-5- methyl-dihydro-furan-2-one | 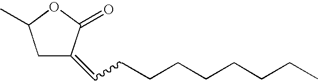 | C₁₄H₂₄O₂ | 224 | 14 |
| (E,Z)-3-decylidene-5- methyl-dihydro-furan-2-one | 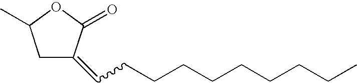 | C₁₅H₂₆O₂ | 238 | 15 |
| (E,Z)-3- cyclohexylmethylidene-5- methyl-dihydrofuran-2-one | 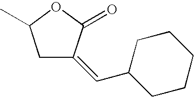 | C₁₂H₁₈O₂ | 194 | 12 |
| gamma-octalactone | 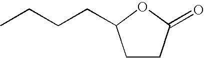 | C₈H₁₄O₂ | 142 | 8 |
| gamma-nonalactone | 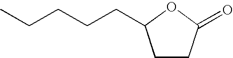 | C₉H₁₆O₂ | 156 | 9 |
| gamma-decalactone | 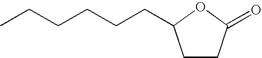 | C₁₀H₁₈O₂ | 170 | 10 |
| gamma-undecalactone | 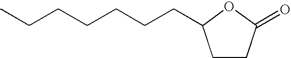 | C₁₁H₂₀O₂ | 184 | 11 |
| gamma-dodecalactone | 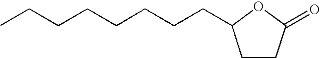 | C₁₂H₂₂O₂ | 198 | 12 |
| 3-hexyldihydro-furan-2-one | 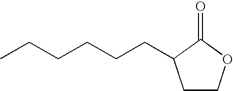 | C₁₀H₁₈O₂ | 170 | 10 |
| 3-heptyldihydro-furan-2-one | 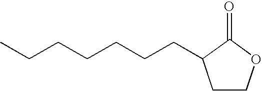 | C₁₁H₂₀O₂ | 184 | 11 |
| cis-3-ethyl-5-methyl- dihydro-furan-2-one | 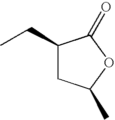 | C₇H₁₂O₂ | 128 | 7 |
| cis-(3-propyl-5-methyl)- dihydro-furan-2-one | 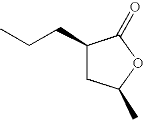 | C₈H₁₄O₂ | 142 | 8 |
| cis-(3-butyl-5-methyl)- dihydro-furan-2-one | 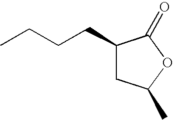 | C₉H₁₆O₂ | 156 | 9 |
| cis-(3-pentyl-5-methyl)- dihydro-furan-2-one | 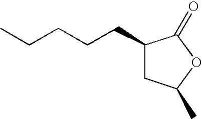 | C₁₀H₁₈O₂ | 170 | 10 |
| cis-3-hexyl-5-methyl- dihydro-furan-2-one | 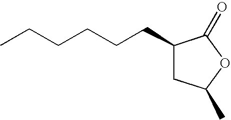 | C₁₁H₂₀O₂ | 184 | 11 |
| cis-3-heptyl-5-methyl- dihydro-furan-2-one | 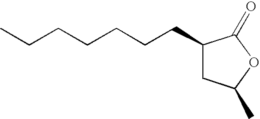 | C₁₂H₂₂O₂ | 198 | 12 |
| cis-3-octyl-5-methyl- dihydro-furan-2-one | 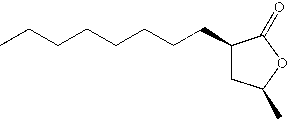 | C₁₃H₂₄O₂ | 212 | 13 |
| cis-3-(3,5,5-trimethylhexyl)-5- methyl-dihydro-furan-2-one | 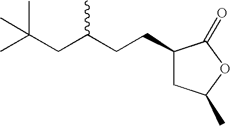 | C₁₄H₂₆O₂ | 226 | 14 |
| 5-methyl-5-hexyl-dihydro- furan-2-one | 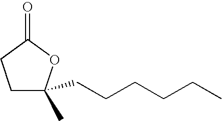 | C₁₁H₂₀O₂ | 184 | 11 |
| 5-methyl-5-octyl-dihydro- furan-2-one | 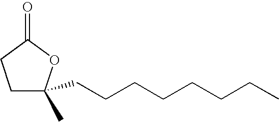 | C₁₃H₂₄O₂ | 212 | 13 |
| Hexahydro-isobenzofuran- 1-one | 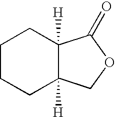 | C₈H₁₂O₂ | 140 | 8 |
| delta-decalactone | 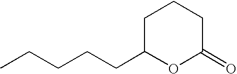 | C₁₀H₁₈O₂ | 170 | 10 |
| delta-undecalactone | 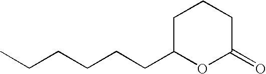 | C₁₁H₂₀O₂ | 184 | 11 |
| delta-dodecalactone | 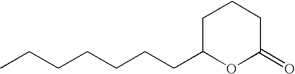 | C₁₂H₂₂O₂ | 198 | 12 |
| mixture of 4-hexyl- dihydrofuran-2-one and 3- hexyl-dihydro-furan-2-one (1.6:1 mole ratio, respectively) | 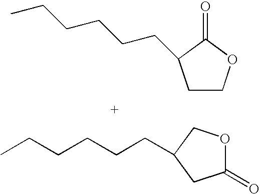 | C₁₀H₁₈O₂ | 170 | 10 |

The lactone compatibilizers generally have a kinematic viscosity of less than about 7 centistokes at 40° C. For instance, gamma-undecalactone has kinematic viscosity of 5.4 centistokes and cis-(3-hexyl-5-methyl)dihydrofuran-2-one has viscosity of 4.5 centistokes at 40° C.

Compositions of the present invention may optionally further comprise polyoxyalkylene glycol ethers represented by the formula R¹[(OR²)ₓOR³]_{y}, wherein: x is selected from integers from 1-3; y is selected from integers from 1-4; R¹ is selected from hydrogen and aliphatic hydrocarbon radicals having 1 to 6 carbon atoms and y bonding sites; R² is selected from aliphatic hydrocarbylene radicals having from 2 to 4 carbon atoms; R³ is selected from hydrogen and aliphatic and alicyclic hydrocarbon radicals having from 1 to 6 carbon atoms; at least one of R¹ and R³ is said hydrocarbon radical; and wherein said polyoxyalkylene glycol ethers have a molecular weight of from about 100 to about 300 atomic mass units and a carbon to oxygen ratio of from about 2.3 to about 5.0. In the present polyoxyalkylene glycol ethers represented by R¹[(OR²)ₓOR³]_{y}: x is preferably 1-2; y is preferably 1; R1 and R³ are preferably independently selected from hydrogen and aliphatic hydrocarbon radicals having 1 to 4 carbon atoms; R² is preferably selected from aliphatic hydrocarbylene radicals having from 2 or 3 carbon atoms, most preferably 3 carbon atoms; the polyoxyalkylene glycol ether molecular weight is preferably from about 100 to about 250 atomic mass units, most preferably from about 125 to about 250 atomic mass units; and the polyoxyalkylene glycol ether carbon to oxygen ratio is preferably from about 2.5 to 4.0 when hydrofluorocarbons are used as fluorocarbon refrigerant, most preferably from about 2.7 to about 3.5 when hydrofluorocarbons are used as fluorocarbon refrigerant, and preferably from about 3.5 to 5.0 when hydrochlorofluorocarbon-containing refrigerants are used as fluorocarbon refrigerant, most preferably from about 4.0 to about 4.5 when hydrochlorofluorocarbon-containing refrigerants are used as fluorocarbon refrigerant.

The R¹ and R³ hydrocarbon radicals having 1 to 6 carbon atoms may be linear, branched or cyclic. Representative R¹ and R³ hydrocarbon radicals include methyl, ethyl, propyl, isopropyl, butyl, isobutyl, sec-butyl, tert-butyl, pentyl, isopentyl, neopentyl, tert-pentyl, cyclopentyl, and cyclohexyl. Where free hydroxyl radicals on the present polyoxyalkylene glycol ether compatibilizers may be incompatible with certain compression refrigeration system materials of construction (e.g. Mylar®), R¹ and R³ are preferably aliphatic hydrocarbon radicals having 1 to 4 carbon atoms, most preferably 1 carbon atom. The R² aliphatic hydrocarbylene radicals having from 2 to 4 carbon atoms form repeating oxyalkylene radicals —(OR²)ₓ— that include oxyethylene radicals, oxypropylene radicals, and oxybutylene radicals. The oxyalkylene radical comprising R² in one polyoxyalkylene glycol ether compatibilizer molecule may be the same, or one molecule may contain different R² oxyalkylene groups. The present polyoxyalkylene glycol ether compatibilizers preferably comprise at least one oxypropylene radical. Where R¹ is an aliphatic or alicyclic hydrocarbon radical having 1 to 6 carbon atoms and y bonding sites, the radical may be linear, branched or cyclic. Representative R¹ aliphatic hydrocarbon radicals having two bonding sites include, for example, an ethylene radical, a propylene radical, a butylene radical, a pentylene radical, a hexylene radical, a cyclopentylene radical and a cyclohexylene radical. Representative R¹ aliphatic hydrocarbon radicals having three or four bonding sites include residues derived from polyalcohols, such as trimethylolpropane, glycerin, pentaerythritol, 1,2,3-trihydroxycyclohexane and 1,3,5-trihydroxycyclohexane, by removing their hydroxyl radicals.

Representative polyoxyalkylene glycol ethers include: CH₃OCH₂CH(CH₃)O(H or CH₃) (propylene glycol methyl (or dimethyl) ether), CH₃O[CH₂CH(CH₃)O]₂(H or CH₃) (dipropylene glycol methyl (or dimethyl) ether), CH₃O[CH₂CH(CH₃)O]₃(H or CH₃) (tripropylene glycol methyl (or dimethyl) ether), C₂H₅OCH₂CH(CH₃)O(H or C₂H₅) (propylene glycol ethyl (or diethyl) ether), C₂H₅O[CH₂CH(CH₃)O]₂(H or C₂H₅) (dipropylene glycol ethyl (or diethyl) ether), C₂H₅O[CH₂CH(CH₃)O]₃(H or C₂H₅) (tripropylene glycol ethyl (or diethyl) ether), C₃H₇OCH₂CH(CH₃)O(H or C₃H₇) (propylene glycol n-propyl (or di-n-propyl) ether), C₃H₇O[CH₂CH(CH₃)O]₂(H or C₃H₇) (dipropylene glycol n-propyl (or di-n-propyl) ether), C₃H₇O[CH₂CH(CH₃)O]₃(H or C₃H₇) (tripropylene glycol n-propyl (or di-n-propyl) ether), C₄H₉OCH₂CH(CH₃)OH (propylene glycol n-butyl ether), C₄H₉O[CH₂CH(CH₃)O]₂(H or C₄H₉) (dipropylene glycol n-butyl (or di-n-butyl) ether), C₄H₉O[CH₂CH(CH₃)O]₃(H or C₄H₉) (tripropylene glycol n-butyl (or di-n-butyl) ether), (CH₃)₃COCH₂CH(CH₃)OH (propylene glycol t-butyl ether), (CH₃)₃CO[CH₂CH(CH₃)O]₂(H or (CH₃)₃) (dipropylene glycol t-butyl (or di-t-butyl) ether), (CH₃)₃CO[CH₂CH(CH₃)O]₃(H or (CH₃)₃) (tripropylene glycol t-butyl (or di-t-butyl) ether), C₅H₁OCH₂CH(CH₃)OH (propylene glycol n-pentyl ether), C₄H₉OCH₂CH(C₂H₅)OH (butylene glycol n-butyl ether), C₄H₉O[CH₂CH(C₂H₅)O]₂H (dibutylene glycol n-butyl ether), trimethylolpropane tri-n-butyl ether (C₂H₅C(CH₂O(CH₂)₃CH₃)₃) and trimethylolpropane di-n-butyl ether (C₂H₅C(CH₂OC(CH₂)₃CH₃)₂CH₂OH).

Compositions of the present invention may optionally further comprise amides represented by the formulae R¹CONR²R³ and cyclo-[R⁴CON(R⁵)—], wherein R¹, R², R³ and R⁵ are independently selected from aliphatic and alicyclic hydrocarbon radicals having from 1 to 12 carbon atoms; R⁴ is selected from aliphatic hydrocarbylene radicals having from 3 to 12 carbon atoms; and wherein said amides have a molecular weight of from about 120 to about 300 atomic mass units and a carbon to oxygen ratio of from about 7 to about 20. The molecular weight of said amides is preferably from about 160 to about 250 atomic mass units. The carbon to oxygen ratio in said amides is preferably from about 7 to about 16, and most preferably from about 10 to about 14. R¹, R², R³ and R⁵ may optionally include substituted hydrocarbon radicals, that is, radicals containing non-hydrocarbon substituents selected from halogens (e.g., fluorine, chlorine) and alkoxides (e.g. methoxy). R¹, R², R³ and R⁵ may optionally include heteroatom-substituted hydrocarbon radicals, that is, radicals which contain the atoms nitrogen (aza-), oxygen (oxa-) or sulfur (thia-) in a radical chain otherwise composed of carbon atoms. In general, no more than three non-hydrocarbon substituents and heteroatoms, and preferably no more than one, will be present for each 10 carbon atoms in R1-3, and the presence of any such non-hydrocarbon substituents and heteroatoms must be considered in applying the aforementioned ratio of carbon to oxygen and molecular weight limitations. Preferred amide compatibilizers consist of carbon, hydrogen, nitrogen and oxygen. Representative R¹, R², R³ and R⁵aliphatic and alicyclic hydrocarbon radicals include methyl, ethyl, propyl, isopropyl, butyl, isobutyl, sec-butyl, tert-butyl, pentyl, isopentyl, neopentyl, tert-pentyl, cyclopentyl, cyclohexyl, heptyl, octyl, nonyl, decyl, undecyl, dodecyl and their configurational isomers.

Preferred amides are those wherein R⁴ in the aforementioned formula cyclo-[R⁴CON(R⁵)-] may be represented by the hydrocarbylene radical (CR⁶R⁷)ₙ, in other words, the formula: cyclo-[(CR⁶R⁷)ₙCON(R⁵)—] wherein: the previously-stated values for (a) ratio of carbon to oxygen and (b) molecular weight apply; n is an integer from 3 to 5; R⁵ is a saturated hydrocarbon radical containing 1 to 12 carbon atoms; R⁶ and R⁷ are independently selected (for each n) by the rules previously offered defining R¹⁻³. In the lactams represented by the formula: cyclo-[(CR⁶R⁷)ₙCON(R⁵)—], all R⁶ and R⁷ are preferably hydrogen, or contain a single saturated hydrocarbon radical among the n methylene units, and R⁵ is a saturated hydrocarbon radical containing 3 to 12 carbon atoms. For example, 1-(saturated hydrocarbon radical)-5-methylpyrrolidin-2-ones. Representative amides include: 1-octylpyrrolidin-2-one, 1-decylpyrrolidin-2-one, 1-octyl-5-methylpyrrolidin-2-one, 1-butylcaprolactam, 1-cyclohexylpyrrolidin-2-one, 1-butyl-5-methylpiperid-2-one, 1-pentyl-5methyl piperid-2-one, 1-hexylcaprolactam, 1-hexyl-5-methylpyrrolid in-2-one, 5-methyl-1-pentylpiperid-2-one, 1,3-dimethylpiperid-2-one, 1-methylcaprolactam, 1-butyl-pyrrolidin-2-one, 1,5-dimethylpiperid-2-one, 1-decyl-5-methylpyrrolidin-2-one, 1-dodecylpyrrolid-2-one, N,N-dibutylformamide and N,N-diisopropylacetamide.

Compositions of the present invention may optionally further comprise ketones represented by the formula R¹COR², wherein R¹ and R² are independently selected from aliphatic, alicyclic and aryl hydrocarbon radicals having from 1 to 12 carbon atoms, and wherein said ketones have a molecular weight of from about 70 to about 300 atomic mass units and a carbon to oxygen ratio of from about 4 to about 13. R¹ and R² in said ketones are preferably independently selected from aliphatic and alicyclic hydrocarbon radicals having 1 to 9 carbon atoms. The molecular weight of said ketones is preferably from about 100 to 200 atomic mass units. The carbon to oxygen ratio in said ketones is preferably from about 7 to about 10. R¹ and R² may together form a hydrocarbylene radical connected and forming a five, six, or seven-membered ring cyclic ketone, for example, cyclopentanone, cyclohexanone, and cycloheptanone. R¹ and R² may optionally include substituted hydrocarbon radicals, that is, radicals containing non-hydrocarbon substituents selected from halogens (e.g., fluorine, chlorine) and alkoxides (e.g. methoxy). R¹ and R² may optionally include heteroatom-substituted hydrocarbon radicals, that is, radicals which contain the atoms nitrogen (aza-), oxygen (keto-, oxa-) or sulfur (thia-) in a radical chain otherwise composed of carbon atoms. In general, no more than three non-hydrocarbon substituents and heteroatoms, and preferably no more than one, will be present for each 10 carbon atoms in R¹ and R², and the presence of any such non-hydrocarbon substituents and heteroatoms must be considered in applying the aforementioned ratio of carbon to oxygen and molecular weight limitations. Representative R¹ and R² aliphatic, alicyclic and aryl hydrocarbon radicals in the general formula R¹COR² include methyl, ethyl, propyl, isopropyl, butyl, isobutyl, sec-butyl, tert-butyl, pentyl, isopentyl, neopentyl, tert-pentyl, cyclopentyl, cyclohexyl, heptyl, octyl, nonyl, decyl, undecyl, dodecyl and their configurational isomers, as well as phenyl, benzyl, cumenyl, mesityl, tolyl, xylyl and phenethyl. Representative ketones that may be present in the present compositions include: 2-butanone, 2-pentanone, acetophenone, butyrophenone, hexanophenone, cyclohexanone, cycloheptanone, 2-heptanone, 3-heptanone, 5-methyl-2-hexanone, 2-octanone, 3-octanone, diisobutyl ketone, 4-ethylcyclohexanone, 2-nonanone, 5-nonanone, 2-decanone, 4-decanone, 2-decalone, 2-tridecanone, dihexyl ketone and dicyclohexyl ketone.

Compositions of the present invention may optionally further comprise nitriles represented by the formula R¹CN, wherein R¹ is selected from aliphatic, alicyclic or aryl hydrocarbon radicals having from 5 to 12 carbon atoms, and wherein said nitriles have a molecular weight of from about 90 to about 200 atomic mass units and a carbon to nitrogen ratio of from about 6 to about 12. R¹ in said nitrile compatibilizers is preferably selected from aliphatic and alicyclic hydrocarbon radicals having 8 to 10 carbon atoms. The molecular weight of said nitrile compatibilizers is preferably from about 120 to about 140 atomic mass units. The carbon to nitrogen ratio in said nitrile compatibilizers is preferably from about 8 to about 9. R¹ may optionally include substituted hydrocarbon radicals, that is, radicals containing non-hydrocarbon substituents selected from halogens (e.g., fluorine, chlorine) and alkoxides (e.g. methoxy). R¹ may optionally include heteroatom-substituted hydrocarbon radicals, that is, radicals which contain the atoms nitrogen (aza-), oxygen (keto-, oxa-) or sulfur (thia-) in a radical chain otherwise composed of carbon atoms. In general, no more than three non-hydrocarbon substituents and heteroatoms, and preferably no more than one, will be present for each 10 carbon atoms in R¹, and the presence of any such non-hydrocarbon substituents and heteroatoms must be considered in applying the aforementioned ratio of carbon to nitrogen and molecular weight limitations. Representative R¹ aliphatic, alicyclic and aryl hydrocarbon radicals in the general formula R¹CN include pentyl, isopentyl, neopentyl, tert-pentyl, cyclopentyl, cyclohexyl, heptyl, octyl, nonyl, decyl, undecyl, dodecyl and their configurational isomers, as well as phenyl, benzyl, cumenyl, mesityl, tolyl, xylyl and phenethyl. Representative nitriles include: 1-cyanopentane, 2,2-dimethyl-4-cyanopentane, 1-cyanohexane, 1-cyanoheptane, 1-cyanooctane, 2-cyanooctane, 1-cyanononane, 1-cyanodecane, 2-cyanodecane, 1-cyanoundecane and 1-cyanododecane. The presence of nitriles in the present compositions are especially useful in compatibilizing HFC refrigerants with aromatic and alkylaryl lubricants.

Compositions of the present invention may optionally further comprise chlorocarbons represented by the formula RClₓ, wherein; x is selected from the integers 1 or 2; R is selected from aliphatic and alicyclic hydrocarbon radicals having 1 to 12 carbon atoms; and wherein said chlorocarbons have a molecular weight of from about 100 to about 200 atomic mass units and carbon to chlorine ratio from about 2 to about 10. The molecular weight of said chlorocarbon compatibilizers is preferably from about 120 to 150 atomic mass units. The carbon to chlorine ratio in said chlorocarbon compatibilizers is preferably from about 6 to about 7. Representative R aliphatic and alicyclic hydrocarbon radicals in the general formula RClₓ include methyl, ethyl, propyl, isopropyl, butyl, isobutyl, sec-butyl, tert-butyl, pentyl, isopentyl, neopentyl, tert-pentyl, cyclopentyl, cyclohexyl, heptyl, octyl, nonyl, decyl, undecyl, dodecyl and their configurational isomers. Representative chlorocarbons include: 3-(chloromethyl)pentane, 3-chloro-3-methylpentane, 1-chlorohexane, 1,6-dichlorohexane, 1-chloroheptane, 1-chlorooctane, 1-chlorononane, 1-chlorodecane, and 1,1,1-trichlorodecane.

Compositions of the present invention may optionally further comprise aryl ethers represented by the formula R¹OR², wherein: R¹ is selected from aryl hydrocarbon radicals having from 6 to 12 carbon atoms;
R² is selected from aliphatic hydrocarbon radicals having from 1 to 4 carbon atoms; and wherein said aryl ethers have a molecular weight of from about 100 to about 150 atomic mass units and a carbon to oxygen ratio of from about 4 to about 20. The carbon to oxygen ratio in said aryl ether compatibilizers is preferably from about 7 to about 10. Representative R¹ aryl radicals in the general formula R¹OR² include phenyl, biphenyl, cumenyl, mesityl, tolyl, xylyl, naphthyl and pyridyl. Representative R² aliphatic hydrocarbon radicals in the general formula R¹OR² include methyl, ethyl, propyl, isopropyl, butyl, isobutyl, sec-butyl and tert-butyl. Representative aromatic ethers include: methyl phenyl ether (anisole), 1,3-dimethyoxybenzene, ethyl phenyl ether and butyl phenyl ether.

Compositions of the present invention may optionally further comprise 1,1,1-trifluoroalkanes represented by the general formula CF₃R¹, wherein R¹ is selected from aliphatic and alicyclic hydrocarbon radicals having from about 5 to about 15 carbon atoms, preferably primary, linear, saturated, alkyl radicals. Representative 1,1,1-trifluoroalkanes include: 1,1,1-trifluorohexane and 1,1,1-trifluorododecane.

Compositions of the present invention may optionally further comprise fluoroethers represented by the general formula R¹OCF₂CF₂H, wherein R¹ is selected from aliphatic and alicyclic hydrocarbon radicals having from about 5 to about 15 carbon atoms, preferably primary, linear, saturated, alkyl radicals. Representative fluoroethers include: C₈H₁₇OCF₂CF₂H and C₆H₁₃OCF₂CF₂H.

Compositions of the present invention may optionally further comprise at least one polyvinyl ether polymer, including polyvinyl ether homopolymers, polyvinyl ether copolymers, and copolymers of vinyl ethers with hydrocarbon alkenes (e.g. ethylene and propylene), and/or functionalized hydrocarbon alkenes (e.g., vinyl acetate and styrene). A representative polyvinyl ether is PVE 32, sold by Idemitsu Kosan and having a kinematic viscosity of 32 centistokes at 40° C.

Compositions of the present invention may optionally further comprise from about 0.5 to about 50 weight percent (based on total amount of compatibilizer) of a linear or cyclic aliphatic or aromatic hydrocarbon containing from 5 to 15 carbon atoms. Representative hydrocarbons include pentane, hexane, octane, nonane, decane, Isopar® H (a high purity C₁₁ to C₁₂ iso-paraffinic), Aromatic 150 (a C₉ to C₁₁ aromatic), Aromatic 200 (a C₉ to C₁₅ aromatic) and Naptha 140. All of these hydrocarbons are sold by Exxon Chemical, USA.

Compositions of the present invention may optionally further comprise a polymeric additive. The polymeric additive may be a random copolymer of fluorinated and non-fluorinated acrylates, wherein the polymer comprises repeating units of at least one monomer represented by the formulae CH₂═C(R¹)CO₂R², CH₂═C(R³)C₆H₄R⁴, and CH₂═C(R⁵)C₆H₄XR⁶, wherein X is oxygen or sulfur; R¹, R³, and R⁵ are independently selected from the group consisting of H and C₁-C₄ alkyl radicals; and R², R⁴, and R⁶ are independently selected from the group consisting of carbon-chain-based radicals containing C, and F, and may further contain H, Cl, ether oxygen, or sulfur in the form of thioether, sulfoxide, or sulfone groups. Examples of such polymeric additives include those disclosed in U.S. Pat. No. 6,299,792, incorporated herein by reference, such as Zonyl® PHS sold by E. I. du Pont de Nemours & Co., Wilmington, Del., 19898, USA. Zonyl® PHS is a random copolymer made by polymerizing 40 weight percent CH₂═C(CH₃)CO₂CH₂CH₂(CF₂CF₂)ₘF (also referred to as Zonyl® fluoromethacrylate or ZFM) wherein m is from 1 to 12, primarily 2 to 8, and 60 weight percent lauryl methacrylate (CH₂═C(CH₃)CO₂(CH₂)₁₁CH₃, also referred to as LMA).

Compositions of the present invention may optionally further contain from about 0.01 to 30 weight percent (based on total amount of compatibilizer) of an additive which reduces the surface energy of metallic copper, aluminum, steel, or other metals found in heat exchangers in a way that reduces the adhesion of lubricants to the metal. Examples of metal surface energy reducing additives include those disclosed in WIPO PCT publication WO 96/7721, such as Zonyl® FSA, Zonyl® FSP and Zonyl® FSJ, all of which are products of E. I. du Pont de Nemours and Co. In practice, by reducing the adhesive forces between the metal and the lubricant (i.e. substituting for a compound more tightly bound to the metal), the lubricant circulates more freely through the heat exchangers and connecting tubing in an air conditioning or refrigeration system, instead of remaining as a layer on the surface of the metal. This allows for the increase of heat transfer to the metal and allows efficient return of lubricant to the compressor.

Compositions of the present invention may comprise a single lactone species or multiple lactone species together in any proportion. Additionally, compositions of the present invention may contain a single lactone or multiple lactones in combination with a compound from another class. For example, a compatibilizer may comprise a combination of gamma-undecalactone and n-octylpyrrolidine-2-one (an amide).

Commonly used refrigeration system additives may optionally be added, as desired, to compositions of the present invention in order to enhance lubricity and system stability. These additives are generally known within the field of refrigeration compressor lubrication, and include anti wear agents, extreme pressure lubricants, corrosion and oxidation inhibitors, metal surface deactivators, free radical scavengers, foam control agents, and the like. In general, these additives are present only in small amounts relative to the overall lubricant composition. They are typically used at concentrations of from less than about 0.1% to as much as about 3% of each additive. These additives are selected on the basis of the individual system requirements. Some typical examples of such additives may include, but are not limited to, lubrication enhancing additives, such as alkyl or aryl esters of phosphoric acid and of thiophosphates. These include members of the triaryl phosphate family of EP lubricity additives, such as butylated triphenyl phosphates (BTPP), or other alkylated triaryl phosphate esters, e.g. Syn-0-Ad 8478 from Akzo Chemicals, tricrecyl phosphates and related compounds. Additionally, the metal dialkyl dithiophosphates (e.g. zinc dialkyl dithiophosphate or ZDDP, Lubrizol 1375) and other members of this family of chemicals may be used in compositions of the present invention. Other antiwear additives include natural product oils and assymetrical polyhydroxyl lubrication additives such as Synergol TMS (International Lubricants). Similarly, stabilizers such as anti oxidants, free radical scavengers, and water scavengers may be employed. Compounds in this category can include, but are not limited to, butylated hydroxy toluene (BHT) and epoxides.

Compatiblizers such as ketones may have an objectionable odor, which can be masked by addition of an odor masking agent or fragrance. Typical examples of odor masking agents or fragrances may include Evergreen, Fresh Lemon, Cherry, Cinnamon, Peppermint, Floral or Orange Peel or sold by Intercontinental Fragrance, as well as d-limonene and pinene. Such odor masking agents may be used at concentrations of from about 0.001% to as much as about 15% by weight based on the combined weight of odor masking agent and compatibilizer.

The present invention further comprises processes for producing refrigeration comprising evaporating the present compositions in the vicinity of a body to be cooled, and thereafter condensing said compositions. The present invention also comprises processes for producing heat comprising condensing the present compositions in the presence of lubricant and compatibilizer in the vicinity of a body to be heated and thereafter evaporating said compositions.

The present invention further comprises methods for providing miscibility and/or solubility of a fluorocarbon refrigerant in a conventional refrigeration lubricant, comprising contacting the fluorocarbon refrigerant with a lubricant in the presence of an effective amount of compatibilizer One may also deliver the a fluorocarbon refrigerant/compatibilzer composition, or a lubricant/compatibilizer composition, of the present invention to a compressor refrigeration or air conditioning system to provide miscibility, and/or solubility of a fluorocarbon refrigerant. The present invention further relates to processes for returning lubricant from a non-compressor zone to a compressor zone in a compression refrigeration or air conditioning system. This method can be accomplished by delivering the composition of the present invention from a non-compressor zone to said compressor zone of the refrigeration or air conditioning system.

Alternatively, one can accomplish return of the lubricant in the system by making the composition as follows: (a) contacting the lubricant of said composition in a non-compressor zone with at least one fluorocarbon refrigerant in the presence of an effective amount of compatibilizer to form a combination of said refrigerant, said lubricant and said compatibilizer; and
(b) transferring the combination from the non-compressor zone to the compressor zone of the refrigeration or air conditioning system.

The present invention further comprises processes for returning a lubricant from a low pressure zone to a compressor zone in a refrigeration system, comprising:
(a) contacting the lubricant in the low pressure zone of the refrigeration system with at least one fluorocarbon refrigerant in the presence of an effective amount of compatibilizer; and
(b) returning the combined fluorocarbon refrigerant and lubricant from the low pressure zone to the compressor zone of the refrigeration system.

The present invention further relates to methods for delivering a compatibilizer to a compression refrigeration or air conditioning system comprising the step of adding any of the compositions of the present invention to said system.

The present invention further relates to methods for lubricating a compressor in a compression refrigeration or air conditioning system comprising adding any of the compositions of the present invention, which contain lubricant, to the compressor.

The compatibilizers of the present invention also provide a means for retrofitting an existing compression refrigeration or air conditioning system that originally contained chlorofluorocarbon (CFC) refrigerant or a hydrofluorocarbon (HCFC) refrigerant and a non-oxygenated conventional compression refrigeration lubricant, such as mineral oil or alkylbenzene oil, without costly and time-consuming flushing to remove residual non-oxygenated lubricant. Presence of residual non-oxygenated lubricant in a vapor compression system can form a second phase, particularly in the evaporator and condenser, which can interfere with heat transfer and result in reduced system energy efficiency and capacity. Addition of a compatibilizer of the present invention allows the formation of a single phase including the non-oxygenated lubricant thus avoiding problems with heat transfer, energy efficiency or capacity as mentioned above.

### EXAMPLES

The following examples are provided to illustrate certain aspects of the present invention, and are not intended to limit the scope of the invention.

Herein, all percentages (%) are in weight percentages unless otherwise indicated. “POE RL-32CF” is used herein as an abbreviation for Uniqema product Emkarate RL32CF, a polyol ester lubricant having a kinematic viscosity of 32 centistokes at 40° C. “POE SW-32” is used herein as an abbreviation for a Castrol polyol ester lubricant having a kinematic viscosity of 32 centistokes at 40° C. “POE 22” is used herein as an abbreviation for Copeland Ultra 22 cc polyol ester lubricant having a kinematic viscosity of 22 centistokes at 40° C. Zerol 150 is an alkylbenzene lubricant having a kinematic viscosity of 32 centistokes at 40° C., and Zerol 300 is an alkylbenzene lubricant having a kinematic viscosity of 57 centistokes at 40° C. The Zerol® products are sold by the Shrieve Corporation. Suniso® 3GS (sometimes herein abbreviated as “3GS”) is a napthenic mineral oil with a kinematic viscosity of 33 centistokes at 40° C., Suniso® 4GS (sometimes herein abbreviated as “4GS”) is a napthenic mineral oil with a kinematic viscosity of 62 centistokes at 40° C. The Suniso® products are sold by Crompton Corporation.

R407C is a refrigerant blend containing 23 wt % HFC-32 (difluoromethane), 25 wt % HFC-125 and 52 wt % HFC-134a. R410A is a refrigerant blend containing 50 wt % HFC-32 and 50 wt % HFC-125.

N-octylpyrrolidin-2-one (Aldrich Chemical Company), gamma-caprolactone (Aldrich Chemical Company), dibutyl phthalate (Aldrich Chemical Company), gamma-octalactone (Aldrich Chemical Company), gamma-nonalactone (Aldrich Chemical Company), gamma-decalactone (Aldrich Chemical Company), gamma-undecalactone (Aldrich Chemical Company), gamma-dodecalactone (Fluka Chemical), 3-hexyldihydro-furan-2-one (TCI America), 3-heptyldihydro-furan-2-one (TCI America), de/ta-decalactone (Aldrich Chemical Company), de/ta-undecalactone (Aldrich Chemical Company), and de/ta-dodecalactone (Aldrich Chemical Company) were purchased from the indicated commercial sources, and distilled under vacuum before measuring phase separation temperatures.

Other lactone compatibilizers tested were prepared in-house by methods described in U.S. patent application Ser. No. 10/910,495 filed Aug. 3, 2004. The lactones prepared by these procedures include, (E,Z)-3ethylidene-5-methyl-dihydro-furan-2-one, (E,Z)-3-propylidene-5-methyl-dihydro-furan-2-one, (E,Z)-3-butylidene-5-methyl-dihydro-furan-2-one, (E,Z)-3-pentylidene-5-methyl-dihydro-furan-2-one, (E,Z)-3-hexylidene-5-methyl-dihydro-furan-2-one, (E,Z)-3-heptylidene-5-methyl-dihydro-furan-2-one, (E,Z)-3-octylidene-5-methyl-dihydro-furan-2-one, (E,Z)-3-nonylidene-5-methyl-dihydro-fu ran-2-one, (E,Z)-3-decylidene-5-methyl-dihydro-fu ran-2-one, (E,Z)-3-cyclohexyl methyl idene-5-methyl-dihydro-fu ran-2-one, cis-3-ethyl-5-methyl-dihydro-furan-2-one, cis-3-propyl-5-methyl-dihydro-furan-2-one, cis-3-butyl-5-methyl-dihydro-furan-2-one, cis-3-pentyl-5-methyl-dihydro-furan-2-one, cis-3-hexyl-5-methyl-dihydro-furan-2-one, cis-3-heptyl-5-methyl-dihydro-fu ran-2-one, cis-3-octyl-5-methyl-dihydro-furan-2-one, and cis-3-(3,5,5-trimethylhexyl)-5-methyl-dihydro-furan-2-one.

Other lactone compatibilizers may be prepared by procedures described herein. Nuclear magnetic resonance (NMR) spectra were recorded on a Varian VXR-500 spectrometer. For reporting NMR data, the following abbreviations are used: s=singlet, d=doublet, t=triplet, q=quartet, m=multiplet, br=broad, dd=doublet of doublets, dt=doublet of triplets, etc.). Gas chromatography (GC) was performed on a Hewlett-Packard 6890 series instrument running HP Chemstation® software and equipped with a DB-5 capillary column from J&W Scientific (Length=10 m, Inner Diameter=0.1 mm, film thickness=0.17 micrometers). Reverse-phase high pressure liquid chromatography (HPLC) purification was performed using an acetonitrile/water gradient elutant on a Gilson high pressure liquid chromatography instrument equipped with an Ansys® Technologies, Inc./Metachem™ Technologies, Inc. preparatory column (Polaris™ 10μ C18-A 150×21.2 mm). High resolution mass spectral data were obtained on a Micromass Prospec magnetic sector GC mass spectrometer using methane chemical ionization and perfluorokerosene as an internal standard.

### Procedure 1

### Preparation of 5-methyl-5-hexyl-dihydro-furan-2-one

The compound 5-methyl-5-hexyl-dihydro-furan-2-one was prepared by a procedure similar to that known in the literature (Kazmierczak, F.; Helquist, P.; J. Org. Chem. Soc., 1989, 54, 3988). Into an oven-dried three-neck 100 mL round-bottomed flask equipped with addition funnel, thermometer, and septum were added 4.92 mL (34.68 mmol) ethyl levulinate and 15 mL dry benzene. The solution was cooled to 0° C. Into a separate flask were added 78.8 mL (39.4 mmol) of a 0.5 M solution of hexylmagnesium bromide in THF. About 65 mL of the THF were distilled off and 45 mL of dry benzene were added. The solution was then transferred via canula to the addition funnel and added drop-wise to the ethyl levulinate solution over 45 min, keeping the temperature below 5° C. After addition was complete the reaction mixture was stirred at 0° C. for 15 min and was then allowed to warm to room temperature. The reaction mixture was poured into 300 mL of ice/10 mL concentrated sulfuric acid with stirring. The aqueous mixture was extracted with 3×150 mL of diethyl ether and the combined extracts were washed with water, 5% sodium bicarbonate, and brine. Drying the extract over anhydrous sodium sulfate followed by removal of the solvent by rotary evaporation gave 6.4 g of a clear yellow oil. Distillation at 0.3 torr yielded 3.61 g of a clear liquid boiling at 80-85° C. (GC purity=96.6%). The sample was further purified by reverse phase prep HPLC yielding 2.1 g of product after removal of elutant under vacuum (GC purity=99.5%). ¹H NMR (500.3 MHz, CDCl₃): [symbol] 0.82 (m, 3H), 1.22 (m, 10H), 1.41 (s, 3H), 1.57 (m, 2H), 1.90 (m, 1H), 2.01 (m, 1H), 2.53 (m, 2H).

### Procedure 2

### Preparation of 5-methyl-5-octyl-dihydro-furan-2-one

The title compound was prepared by the method of Procedure 1 using octylmagnesium bromide (39.36 mmol) and ethyl levulinate 4.92 mL (34.7 mmol). Distillation at 0.3 mm Hg yielded 5.2 g of the title compound (GC purity=96.5%). Further purification of the compound was accomplished by reverse-phase preparatory HPLC (GC purity=99.5%). ¹H NMR (500.3 MHz, CDCl₃): δ 0.74 (m, 3H), 1.13 (m, 12H), 1.24 (s, 3H), 1.58 (m, 2H), 1.80 (m, 1H), 1.92 (m, 1H), 2.44 (m, 2H).

### Procedure 3

### Preparation of Hexahydro-isobenzofuran-1-one

To a 100 mL three-necked round-bottomed flask were added 1.33 g (35.03 mmol) of sodium borohydride and 15 mL dry THF under a dinitrogen atmosphere. The suspension was cooled to 0° C. using an ice bath, and a solution of 3.6 g (23.3 mmol) of cis-cyclohexane dicarboxylic anhydride (Aldrich Chemical Company) was added dropwise over 20 min. After the addition was complete the reaction mixture was allowed to warm to room temperature and the stirring was continued for 12 h. The reaction mixture was cooled to 0° C. and 6 N HCl was added until the solution was acidic to litmus paper. The THF was removed in vacuo and 10 mL of water were added. The solution was extracted into diethyl ether (3×25 mL) and the combined ether extracts were washed once with 5% sodium bicarbonate and once with brine. After drying over anhydrous sodium sulfate, the solvent was removed to give 3.2 g of clear oil product. Distillation of the crude product at 0.3 mm Hg yielded 2.51 g of clear liquid that boiled at 51-54° C. (GC purity=98.9%). ¹H NMR (500.3 MHz, CDCl₃): [symbol] 1.08 (m, 3H), 1.45 (m, 2H), 1.50 (m, 1H), 1.67 (m, 1H), 1.95 (m, 1H), 2.34 (m, 1H), 1.49 (m, 1H), 3.82 (m, 1H), 4.06 (m, 1H).

### Procedure 4

### Preparation of 4-hexyl-dihydro-furan-2-one and 3-hexyl-5-dihydro-furan-2-one Mixture

The following procedure to prepare a mixture of 3-hex-2-enyl-5-dihydro-furan-2-one and 4-hex-2-enyl-dihydro-furan-2-one was adapted from a literature procedure (Bergmeier, S. C.; Lee, W. K.; Rapoport, H J. Org. Chem., 1993, vol. 58, pp 5019-5022). To a three-neck 250 mL round bottom flask equipped with an addition funnel, condenser, and thermometer adapter under a nitrogen atmosphere were added 2.34 g (61.88 mmol) sodium borohydride (Aldrich Chemical Company) and 40 mL of anhydrous tetrahydrofuran. To this solution was added dropwise a solution of 10.0 mL (54.88 mmol) of hex-2-enylsuccinic anhydride (Avocado Chemical Co.) in 60 mL of tetrahydrofuran through the addition funnel. The addition was done at a rate such that the temperature did not rise above 25° C. Upon completion of addition the reaction mixture was stirred for 1.5 h. The mixture was cooled to 10° C. and a solution of 7.5 mL of ethanol and 7.5 mL concentrated hydrochloric acid was added dropwise. Upon completion of addition the reaction mixture was refluxed for 16 h. The mixture was cooled, transferred to a one-neck flask and concentrated to about one half volume on a rotary evaporator. The solids were then filtered from the liquid portion, and the filtrate diluted with 40 mL brine. The resulting solution was extracted with portions of ethyl acetate and the combined organic extracts were dried over anhydrous sodium sulfate, filtered, and concentrated to give 10.8 g of crude product. Distillation through a short path column at 0.3 mm Hg and yielded a fraction boiling at 85° C. and gave 5.1 g (56%) of 3-hex-2-enyl-5-dihydro-furan-2-one and 4-hex-2-enyl-dihydro-furan-2-one in a 1.6 to 1 mole ratio of the isomers favoring the 4-isomer. ¹H NMR (500.9 MHz, CDCl₃): δ 0.89 (m, 3H), 1.2 (m, 1H), 1.38 (m, 2H), 1.67 (m, 1H), 1.88 (m, 1H), 2.0 (m, 2H), 2.23 (m, 2H), 2.33 (m, 1H), 2.62 (overlapping m, 2H and 1H), 3.56 (m, 1H), 3.68 (m, 1H), 4.2 (m, 1H), 4.31 (m, 1H), 4.38(m, 1H), 5.33 (m, 1H), 5.5 (m, 1H). ¹³C NMR (125. 9 MHz, CDCl₃): δ 13.60, 13.76, 22.48, 22.68, 22.71, 27.70, 27.95, 29.11, 29.42, 29.97, 30.46, 33.22, 33.95, 34.08, 34.59, 35.30, 35.64, 36.08, 39.33, 44.94, 62.00, 66.60, 72.82, 72.88, 124.99, 125.12, 125, 68, 125.75, 132.97, 133.17, 134,01, 134.09, 177.21, 179.09. GC purity=88%. Liquid chromatogram mass spectral analysis: Theoretical m/e (mass+H+) for C₁₀H₁₆O₂=169.1. Found: 169.2.

A flask was charged with 2.06 g of 3-hex-2-enyl-5-dihydro-furan-2-one and 4-hex-2-enyl-dihydro-furan-2-one (as prepared above), 0.210 g of 10% palladium on carbon catalyst, 40.0 ml of ethanol, and 10 ml of methanol. This was placed on a high vacuum line and the mixture was degassed. It was then stirred overnight under one atmosphere of dihydrogen until uptake of hydrogen was complete The catalyst was then removed by filtration and the solvent was removed on a rotary evaporator. The crude product was placed into an oil sublimator and sublimed on a high vacuum line (10⁻³-10⁻⁴ torr) yielding 0.861 g of 3-hexyl-5-dihydro-furan-2-one and 4-hexyl-dihydro-furan-2-one mixture as a colorless liquid. ¹H NMR (500 MHz, CD₂Cl₂) (mixture of 4-hexyl and 3-hexyl isomers with 4-hexyl/3-hexyl isomers in a molar ratio of 1.7/1, respectively): δ 4.38 (m, 4-hexyl isomer), 4.29 (td, J=8.9, 2.8 Hz, 3-hexyl isomer), 4.14 (td, J=9.3, 6.9 Hz, 3-hexyl isomer), 3.88 (m, 4-hexyl), 2.52 (m, 3-hexyl and 4-hexyl isomers), 2.36 (m, 3-hexyl isomer), 2.14 (m, 4-hexyl isomer), 1.94-1.76 (br m), 1.53-1.22 (br m), 0.89 (overlapping triplets, J=7.0 Hz). ¹³C{¹H} NMR (126 MHz, CD₂Cl₂): δ 179.80 (3-hexyl isomer), 177.45 (4-hexyl isomer), 73.84 (4-hexyl isomer), 66.91 (3-hexyl isomer), 39.61 (3-hexyl isomer), 36.19 (4-hexyl isomer), 34.90 (4-hexyl isomer), 33.52 (4-hexyl isomer), 32.10 (2C, 3-hexyl and 4-hexyl isomer), 30.81 (3-hexyl isomer), 29.59 (4-hexyl isomer), 29.47 (3-hexyl isomer), 29.08 (3-hexyl isomer), 27.76, 27.73, 23.02, 23.00, 14.22 (2C). Theoretical (mass+H⁺) for C₁₀H₁₈O₂: 171.1385; Found: 171.1390.

### Example 1

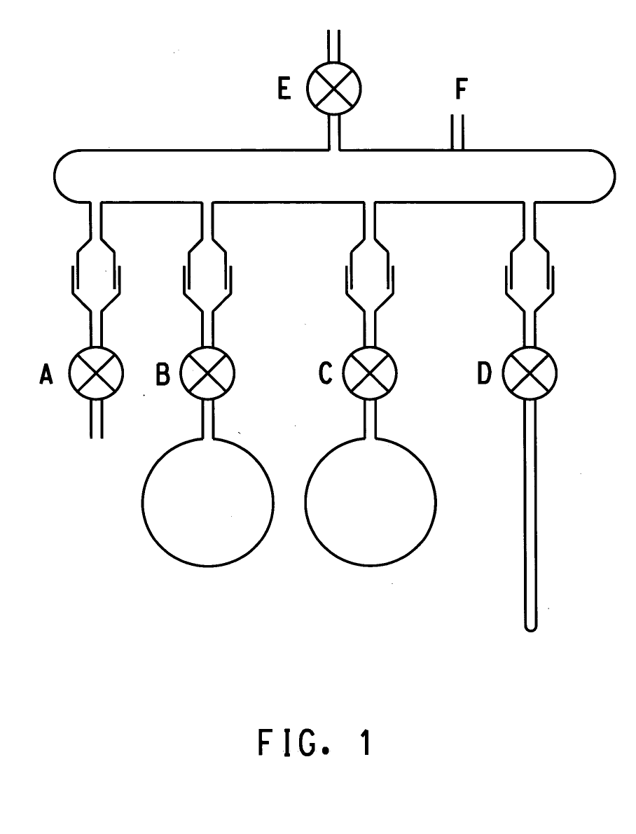

The phase separation temperatures for lactone compatibilizers of the present invention when combined with Zerol® 150 alkylbenzene oil were determined. In a typical procedure, an amount (in the range of 195 to 250 mg) of a previously prepared mixture of lubricant and compatibilizer was accurately weighed into a glass tube apparatus. The glass tube was sealed at one end, and the other end was sealed to a Teflon® vacuum valve stopcock. This entire apparatus was tared, and was attached at valve E to a high vacuum line capable of achieving 10⁻⁴ to 10⁻⁵ torr (See FIG. 1). The pressure was measured by a mercury manometer, F. All five valves, A, B, C, D and E were attached to the manifold via greased ground-glass joints. Valve A joined the manifold to the source of refrigerant. Valve B joined a flask comprising fluorocarbon refrigerant, once loaded into the manifold. Valve C joined a 125.5 mL calibrated vessel to the manifold. And valve D joined a 5 mm OD in leg glass tube 150 mm in length containing oil and compatibilizer.

The glass tube, refrigerant container, and calibrated volume were evacuated by opening valve B, C, D, and E, and keeping valve A closed. After vacuum was achieved, Valve D and E were closed. An atmosphere of refrigerant was introduced into the vacuum line by opening Valve A. After closing valve A, the refrigerant was condensed into the refrigerant container by cooling with a liquid nitrogen bath. Valve E was opened to remove any residual air. Valve E was closed, and the refrigerant container was allowed to warm until the desired pressure was reached as indicated on the mercury manometer whereupon Valve C was closed trapping a known amount of refrigerant in the calibrated volume. The excess refrigerant was condensed back into the refrigerant container by cooling with a liquid nitrogen bath, Valve B was closed, and Valve E was opened to remove all residual gases. The glass tube was cooled in a liquid nitrogen bath, and the refrigerant was transferred from the calibrated volume to the glass tube by closing Valve E, and opening Valves C and D. Valve D was then sealed after all the refrigerant had transferred into the glass tube. The glass tube apparatus was removed from the vacuum line, and the tube was allowed to warm while maintaining the tube behind appropriate protective shielding for safety purposes throughout the rest of the procedure owing to the positive pressure in the glass tube. After removal of grease from the ground glass joint, the previously tared glass tube apparatus was weighed to ensure the appropriate mass of refrigerant had been added to the tube. In a typical experiment, the composition in the tube was near 50.0 wt % R134a, 25.0 wt % Zerol® 150 and 25.0 wt % of compatibilizer.

The phase separation temperature of the mixture was determined by manually shaking the contents of the glass tube while cooling the mixture by one degree Centigrade intervals until a cloudpoint/phase separation was visually observed. Results are shown in Table II in comparison with an amide compatibilizer, N-octyl-pyrrolidin-2-one.

The data in Table II show significantly lower phase separation temperatures (PST) versus HFC-134a with pure Zerol® 150 alkylbenzene that has a phase separation temperature of 130° C. For several lactone compatibilizers, PSTs are also lower than the PST of N-octyl-pyrrolidin-2-one.

TABLE II

| | | | | | Actual Weight % | |
|---|---|---|---|---|---|---|
| | | | | Carbon to | Each Component in | Phase |
| | | | Molecular | Carbonyl | Tube (Zero ® 150: | Separation |
| | | Molecular | Weight | Oxygen | Compatibilizer: | Temperature |
| Compatibilizer | Molecular Structure | Formula | (amu) | Ratio | 134a Refrigerant) | (deg C) |
| (E,Z)-3-ethylidene- 5-methyl-dihydro- furan-2-one | 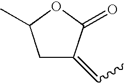 | C₇H₁₀O₂ | 126 | 7 | 25.3:24.9:49.8 | 24 |
| (E,Z)-3-propylidene-5- methyl-dihydro- furan-2-one | 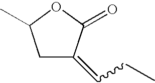 | C₈H₁₂O₂ | 140 | 8 | 25.6:23.9:50.5 | 12 |
| (E,Z)-3-butylidene-5- methyl-dihydro- furan-2-one | 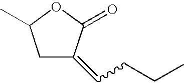 | C₉H₁₄O₂ | 154 | 9 | 24.9:25.5:49.6 | 9 |
| (E,Z)-3-pentylidene-5- methyl-dihydro- furan-2-one | 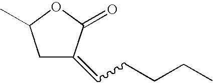 | C₁₀H₁₆O₂ | 168 | 10 | 25.3:25.1:49.6 | 0 |
| (E,Z)-3-Hexylidene- methyl-dihydro- furan-2-one | 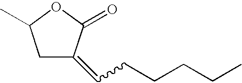 | C₁₁H₁₈O₂ | 182 | 11 | 25.2:25.1:49.7 | −7 |
| (E,Z)-3-Heptylidene-5- methyl-dihydro- furan-2-one | 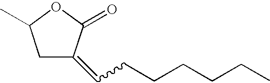 | C₁₂H₂₀O₂ | 196 | 12 | 24.7:24.9:50.4 | −6 |
| (E,Z)-3-octylidene-5- methyl-dihydro- furan-2-one | 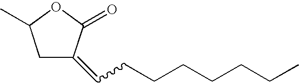 | C₁₃H₂₂O₂ | 210 | 13 | 25.1:25.1:49.8 | −8 |
| (E,Z)-3-nonylidene-5- methyl-dihydro- furan-2-one | 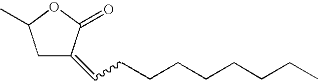 | C₁₄H₂₄O₂ | 224 | 14 | 25.4:25.1:49.5 | 4 |
| (E,Z)-3-decylidene-5- methyl-dihydro- furan-2-one | 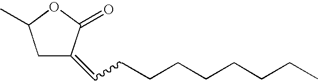 | C₁₅H₂₆O₂ | 238 | 15 | 25.2:24.9:49.9 | 13 |
| (E,Z)-3-(3,5,5- trimethylhexylidene)-5- methyl-dihydrofuran-2- one | 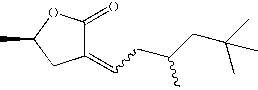 | C₁₄H₂₄O₂ | 224 | 14 | 25.0:24.9:50.1 | 3 |
| (E,Z)-3- cyclohexylmethylidene- 5-methyl-dihydrofuran-2- one | 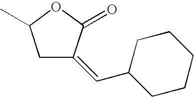 | C₁₂H₁₈O₂ | 194 | 12 | 24.9:24/9:50.2 | −2 |
| gamma-octalactone | 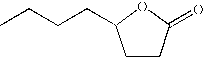 | C₈H₁₄O₂ | 142 | 8 | 25.2:24.6:50.2 | 10 |
| gamma-nonalactone | 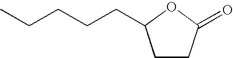 | C₉H₁₆O₂ | 156 | 9 | 25.3:25.2:49.5 | −2 |
| gamma-decalactone | 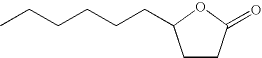 | C₁₀H₁₈O₂ | 170 | 10 | 25.1:24.7:50.2 | −3 |
| gamma-undecalactone | 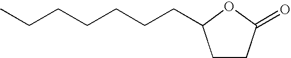 | C₁₁H₂₀O₂ | 184 | 11 | 25.0:25.0:50.0 | −6 |
| gamma-dodecalactone | 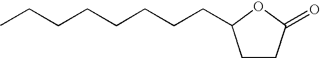 | C₁₂H₂₂O₂ | 198 | 12 | 25.2:25.2:49.6 | −6 |
| 3-hexyldihydro- furan-2-one | 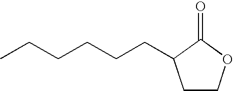 | C₁₀H₁₈O₂ | 170 | 10 | 23.9:24.5:51.6 | 5 |
| 3-heptyldihydro- furan-2-one | 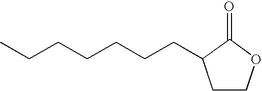 | C₁₁H₂₀O₂ | 184 | 11 | 24.7:24.7:50.6 | 0 |
| cis-3-ethyl-5-methyl- dihydro-furan-2-one | 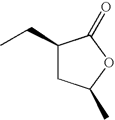 | C₇H₁₂O₂ | 128 | 7 | 24.8:24.9:50.3 | >25 |
| cis-(3-propyl-5-methyl)- dihydro-furan-2-one | 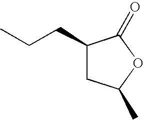 | C₈H₁₄O₂ | 142 | 8 | 25.5:25.4:49.1 | 14 |
| cis-(3-butyl-5-methyl)- dihydro-furan-2-one | 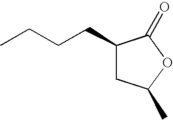 | C₉H₁₆O₂ | 156 | 9 | 24.9:25.6:49.5 | 10 |
| cis-(3-pentyl-5-methyl)- dihydro-furan-2-one | 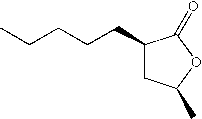 | C₁₀H₁₈O₂ | 170 | 10 | 25.3:25.1:49.6 | −1 |
| cis-3-hexyl-5-methyl- dihydro-furan-2-one | 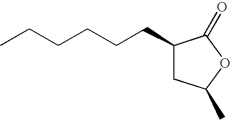 | C₁₁H₂₀O₂ | 184 | 11 | 24.8:24.9:50.3 | −9 |
| cis-3-heptyl-5-methyl- dihydro-furan-2-one | 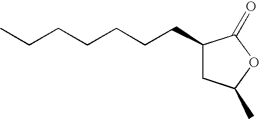 | C₁₂H₂₂O₂ | 198 | 12 | 24.9:24.7:50.4 | phase gelled and/or precipitated at −11 deg C |
| cis-3-(3,5,5- trimethylhexyl)-5- methyl-dihydro- furan-2-one | 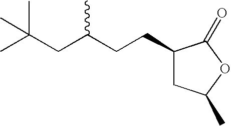 | C₁₄H₂₆O₂ | 226 | 14 | 24.8:25.0:50.2 | 2 |
| 5-methyl-5-hexyl- dihydro-furan-2-one | 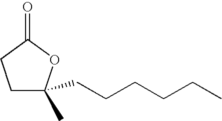 | C₁₁H₂₀O₂ | 184 | 11 | 25.0:25.4:49.6 | −2 |
| 5-methyl-5-octyl- dihydro-furan-2-one | 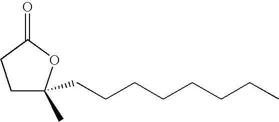 | C₁₃H₂₄O₂ | 212 | 13 | 24.9:24.9:50.2 | −4 |
| Hexahydro- isobenzofuran-1-one | 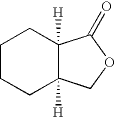 | C₈H₁₂O₂ | 140 | 8 | 24.9:24.8:50.2 | 4 |
| delta-decalactone | 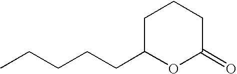 | C₁₀H₁₈O₂ | 170 | 10 | 24.7:24.9:50.4 | −10 |
| delta-undecalactone | 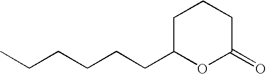 | C₁₁H₂₀O₂ | 184 | 11 | 24.9:25.3:49.8 | −12 |
| delta-dodecalactone | 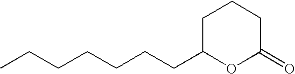 | C₁₂H₂₂O₂ | 198 | 12 | 25.6:25.0:49.4 | −13 |
| mixture of 4-hexyl- dihydrofuran-2-one and 3-hexyl-dihydro- furan-2-one (1.6:1 mole ratio,respectively) | 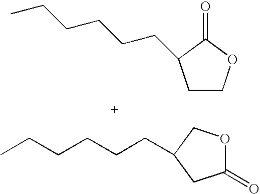 | C₁₀H₁₈O₂ | 170 | 10 | 25.2:25.0:49.8 | −3 |

Comparative Data

| | | | | | | |
|---|---|---|---|---|---|---|
| gamma-caprolactone | 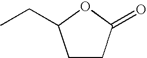 | C₆H₁₀O₂ | 114 | 6 | — | Immiscible with Zerol ®150 |
| N-octylpyrrolidin-2-one | 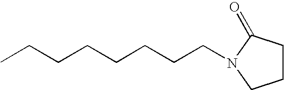 | C₁₂H₂₃NO | 126 | 12 | 25.4:25.0:49.6 | −4 |
| dibutyl phthalate | 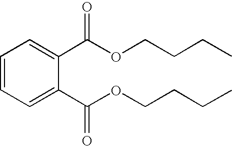 | C₁₆H₂₂O₄ | 140 | 8 | 24.9:24.7:50.4 | 18 |

### Example 2

Tests were conducted to determine if R407C (23 wt % HFC-32 and 25 wt % HFC-125, 52 wt % HFC-134a) could be used in a ductless split R22 Goodman heat pump (Model HDP-24), using conventional lubricant oil Zerol® 150 and compatibilizers. The heat pump was outfitted with an R22 Bristol hermetic reciprocating compressor (H25B24QABCB) equipped with a sight glass and level tube in the oil sump. The fan-coil unit was installed in the indoor room of an environmental chamber and the outdoor unit was installed in the outdoor room. The system was charged with about 1700 grams of refrigerant and 1000 ml of oil containing compositions of the present invention. Refrigerant R407C with POE 22 oil and R22 with Zerol® 150 were used as baselines for comparison. Tests were conducted at ASHRAE cooling B. The indoor room was controlled at 80° F. and 50% relative humidity, the outdoor room at 82° F. and 40% relative humidity. Results from air side and refrigerant side measurements are shown in Table III.

Results show increased energy efficiency ratio (EER) and at least equivalent capacity when lactone is added to Zerol® 150, when compared with R22/Zerol® 150 and R407C/POE 22. Oil return is also equivalent to the baselines.

TABLE III
Cooling Test

| | Oil Level | | |
|---|---|---|---|
| | During Test | Capacity | |
| Oil Composition | (cm) | (Kbtu/H) | EER |
| Air Side: | | | |
| R22/Zerol ® 150 | 2.75 | 18.2 | 7.16 |
| R407C/POE 22 | 2.75 | 17.9 | 7.02 |
| R407C/35 wt % gamma- | 2.75 | 17.9 | 7.19 |
| undecalactone in Zerol ® 150 | | | |
| Refrigerant Side: | | | |
| R22/Zerol ® 150 | 2.75 | 18.9 | 7.43 |
| R407C/POE 22 | 2.75 | 18.3 | 7.16 |
| R407C/35 wt % gamma- | 2.75 | 18.6 | 7.50 |
| undecalactone in Zerol ® 150 | | | |

### Example 3

Compatibilizers of the present invention were mixed with Zerol® 150 and placed in shallow dishes in a 50% constant humidity chamber. NOP is n-octyl-pyrrolidin-2-one and GUDL is gamma-undecalactone. Periodic samples of the compositions were taken and analyzed by Karl Fischer titration for ppm water. Results are shown versus POE lubricants in Table IV below.

TABLE IV

| | Hours | | | | | | | |
|---|---|---|---|---|---|---|---|---|
| | 0 | 1 | 2 | 4 | 8 | 24 | 48 | 72 |
| 15% NOP in | 32 | 79 | 113 | 164 | 219 | 386 | 638 | 681 |
| Z150 | | | | | | | | |
| 35% NOP in | 63 | 163 | 274 | 446 | 693 | 1927 | 2951 | 3429 |
| Z150 | | | | | | | | |
| 15% GUDL in | 8 | 30 | 49 | 75 | 94 | 163 | 224 | 312 |
| Z150 | | | | | | | | |
| 35% GUDL in | 16 | 57 | 103 | 154 | 225 | 452 | 640 | 719 |
| Z150 | | | | | | | | |
| POE 22 | 93 | 140 | 200 | 278 | 383 | 699 | 966 | 1124 |
| POE SW32 | 32 | 98 | 172 | 263 | 334 | 703 | 982 | 1192 |

Results show compositions of the present invention absorb less water than POE and significantly less water than OP/Z150 formulations. Since compositions of the present invention do absorb some water, they also have lower risk of having free water available than Zerol® 150. Free water can freeze in expansion devices and cause compressor failure.

### Example 4

Compositions of the present invention were tested for thermal stability. Stainless steel, aluminum and copper coupons were placed in sealed glass tubes containing R407C refrigerant, Zerol® 150 lubricant and compositions of the present invention. In three cases, 500 ppm water was added. Initial acid number was measured using a titrant of 0.01 N tetrabutyl ammonia hydroxide in toluene/isopropanol solvent. Tubes were then held for 14 days at 175° C. After testing, coupons were observed for corrosion and samples re-analyzed for acid number. Results are shown in Table V below.

Results show compositions of the present are thermally stable even in the presence of 500 ppm water, indicating no significant acid formation. POEs in the presence of water caused corrosion of copper due to hydrolysis and acid formation.

TABLE V

| | | | | Initial | |
|---|---|---|---|---|---|
| | | | | Acid | Final Acid |
| | Copper | Aluminum | Steel | number | Number |
| | Appearance | Appearance | Appearance | (ppm) | (ppm) |
| R407C/Zerol ® 150 + 35 | No | No | No | 12.5 | 20.3 |
| wt % gamma- | observable | observable | observable | | |
| undecalactone | changes | changes | changes | | |
| R407C/Zerol ® 150 + 35 | No | No | No | 20.0 | 22.7 |
| wt % gamma- | observable | observable | observable | | |
| undecalactone + 500 ppm | changes | changes | changes | | |
| H2O | | | | | |
| R407C/POE | Corrosion | No | No | 165.6 | 361.3 |
| RL-32CF | and | observable | observable | | |
| | discoloration | changes | changes | | |
| | observed | | | | |
| R407C/POE | Corrosion | No | No | 168.2 | 692.9 |
| RL-32CF + 500 ppm | and | observable | observable | | |
| H2O | discoloration | changes | changes | | |
| | observed | | | | |
| R407C/POE 22 | Corrosion | No | No | 174.8 | 391.8 |
| | and | observable | observable | | |
| | discoloration | changes | changes | | |
| | observed | | | | |
| R407C/POE 22 + 500 ppm | Corrosion | No | No | 186.1 | 1127.9 |
| H2O | and | observable | observable | | |
| | discoloration | changes | changes | | |
| | observed | | | | |

### Example 5

Compositions of the present invention were evaluated for acute skin irritation/corrosive potential in New Zealand White rabbits. An aliquot of 0.5 mL of undiluted compatibilizer was administered to a localized site on the backs of the animals. The test sites were covered with a semi-oclusive dressing to ensure contact between the skin and the test substance. The animals were exposed to the test substances for approximately 4 hours. The test sites were evaluated for erythrema, edema, and other evidence of dermal effects for up to 72 hours following the removal of the test substance. Observed dermal effects were scored according to the Draize scale. The reversibility of dermal effects was assessed for up to 14 days, as necessary. Under the described conditions the compatibilizers are classified as shown in Table VI below.

TABLE VI

| Compatibilizer | Observations | Classification |
|---|---|---|
| N,N-Dimethylnonanamide | Severe erythrema | Severe irritant |
| | or edema | |
| N-octyl pyrrolidin-2-one | Severe erythrema | Severe irritant |
| | or edema | |
| 5-methyl-n-cyclohexyl | Necrosis | Corrosive |
| pyrrolidin-2-one | | |
| 5-methyl-n-octyl-pyrrolidin-2-one | Necrosis | Corrosive |
| 3-hexyl-5-methyl- | No irritation | Not a skin irritant |
| gammabutyrolactone | | |
| Gamma-undecalactone | No irritation | Not a skin irritant |

Results show lactone compatibilizers have no skin irritation, which is a significant improvement compared with pyrrolidone or amide compatibilizers. This is particularly important in the refrigeration and air conditioning industry where oils are often handled by service technicians.

1. A composition for use in a compression refrigeration and air conditioning system, said composition comprising:
(a) at least one fluorocarbon refrigerant selected from the group consisting of hydrofluorocarbons, hydrochlorofluorocarbons, perfluorocarbons, and hydrofluorocarbon ethers; and
(b) at least one compatibilizer selected from the group consisting of compounds represented by formula I, II, and III: 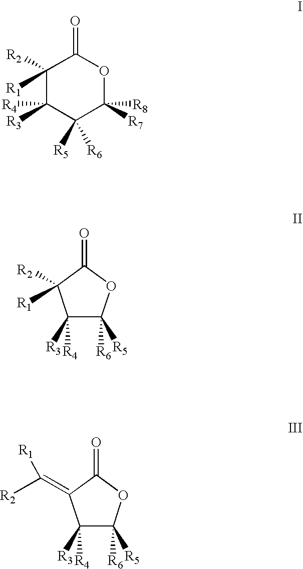
wherein, R₁ through R₈ are independently selected from the group consisting of hydrogen, linear, branched, cyclic, bicyclic, saturated and unsaturated hydrocarbyl radicals; the carbon to ester functional group carbonyl oxygen ratio is from about 7 to about 15; and the molecular weight is from about 100 to about 300 atomic mass units.

2. The composition of claim 1 further comprising at least one additional compound selected from the group consisting of:
(a) polyoxyalkylene glycol ethers represented by the formula R¹[(OR²)ₓOR³]_{y}, wherein: x is selected from integers from 1 to 3; y is selected from integers from 1 to 4; R¹ is selected from hydrogen and aliphatic hydrocarbon radicals having 1 to 6 carbon atoms and y bonding sites; R² is selected from aliphatic hydrocarbylene radicals having from 2 to 4 carbon atoms; R³ is selected from hydrogen, and aliphatic and alicyclic hydrocarbon radicals having from 1 to 6 carbon atoms; at least one of R¹ and R³ is selected from said hydrocarbon radicals; and wherein said polyoxyalkylene glycol ethers have a molecular weight of from about 100 to about 300 atomic mass units and a carbon to oxygen ratio of from about 2.3 to about 5.0;
(b) amides represented by the formulae R¹CONR²R³ and cyclo-[R⁴CON(R⁵)—], wherein R¹, R², R³ and R⁵ are independently selected from aliphatic and alicyclic hydrocarbon radicals having from 1 to 12 carbon atoms; R⁴ is selected from aliphatic hydrocarbylene radicals having from 3 to 12 carbon atoms; and wherein said amides have a molecular weight of from about 120 to about 300 atomic mass units and a carbon to oxygen ratio of from about 7 to about 20,
(c) ketones represented by the formula R¹COR², wherein R¹ and R² are independently selected from aliphatic, alicyclic and aryl hydrocarbon radicals having from 1 to 12 carbon atoms, and wherein said ketones have a molecular weight of from about 70 to about 300 atomic mass units and a carbon to oxygen ratio of from about 4 to about 13,
(d) nitriles represented by the formula R¹CN, wherein R¹ is selected from aliphatic, alicyclic or aryl hydrocarbon radicals having from 5 to 12 carbon atoms, and wherein said nitriles have a molecular weight of from about 90 to about 200 atomic mass units and a carbon to nitrogen ratio of from about 6 to about 12,
(e) chlorocarbons represented by the formula RClₓ, wherein; x is selected from the integers 1 or 2; R is selected from aliphatic and alicyclic hydrocarbon radicals having from 1 to 12 carbon atoms; and wherein said chlorocarbons have a molecular weight of from about 100 to about 200 atomic mass units and carbon to chlorine ratio from about 2 to about 10,
(f) aryl ethers represented by the formula R¹OR², wherein: R¹ is selected from aryl hydrocarbon radicals having from 6 to 12 carbon atoms; R² is selected from aliphatic hydrocarbon radicals having from 1 to 4 carbon atoms; and wherein said aryl ethers have a molecular weight of from about 100 to about 150 atomic mass units and a carbon to oxygen ratio of from about 4 to about 20,
(g) 1,1,1-trifluoroalkanes represented by the formula CF₃R¹, wherein R¹ is selected from aliphatic and alicyclic hydrocarbon radicals having from about 5 to about 15 carbon atoms; and
(h) fluoroethers represented by the formula R¹OCF₂CF₂H, wherein R¹ is selected from aliphatic and alicyclic hydrocarbon radicals having from about 5 to about 15 carbon atoms.

3. The composition of claim 1, further comprising at least one hydrocarbon selected from the group consisting of decanes, undecanes, dodecanes, tridecanes, tetradecanes, pentadecanes and hexadecanes.

4. The composition of claim 1 further comprising at least one lubricant selected from the group consisting of paraffins, napthenes, aromatics, and poly-alpha-olefins.

5. The composition of claim 1, further comprising an effective amount of a fragrance.

6. A process for producing refrigeration comprising evaporating the composition of claim 1, 2, 3, 4 or 5 in the vicinity of a body to be cooled, and thereafter condensing said composition.

7. A process for producing heat comprising condensing the composition of claim 1, 2, 3, 4 or 5 in the vicinity of a body to be heated, and thereafter evaporating said composition.

8. A method of using the composition of claim 1, 2, 3, 4 or 5, said method comprising delivering said composition to a compression refrigeration or air conditioning system to result in delivery of the compatibilizer comprised therein.

9. A method of making the composition of claim 4, said method comprising contacting said lubricant in a non-compressor zone of a compression refrigeratin or air conditioning system with said fluorocarbon refrigerant in the presence of an effective amount of said compatibilizer, to produce said composition.

10. A method of using the composition of claim 9 to return lubricant from a non-compressor zone to a compressor zone in a compression refrigeration or air conditioning system, said method comprising:
(a) transferring said combination from said non-compressor zone to said compressor zone of said refrigeration or air conditioning system.

11. A method of using the composition of claim 9, said method comprising delivering said composition to a compressor refrigeration or air conditioning system to provide miscibility, and/or solubility of a fluorocarbon refrigerant with a refrigeration lubricant.

12. A method for lubricating a compressor in a compression refrigeration or air conditioning system, comprising the step of adding to said compressor the composition of claim 4.

13. A composition for use in compression refrigeration and air conditioning system comprising:
(a) at least one lubricant selected from the group consisting of paraffin, napthene, aromatic, and poly-alpha-olefin; and
(b) at least one compatibilizer selected from the group consisting of compounds represented by formula I, II, and III: 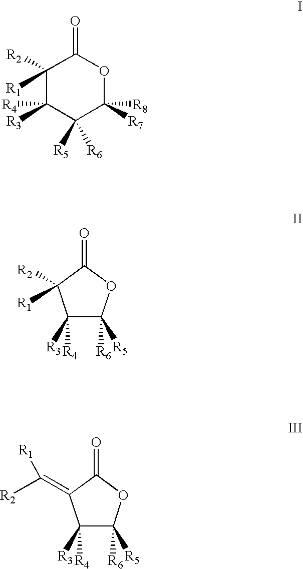
wherein, R₁ through R₈ are independently selected from the group consisting of hydrogen, linear, branched, cyclic, bicyclic, saturated and unsaturated hydrocarbyl radicals; and wherein the carbon to ester functional group carbonyl oxygen ratio is from about 7 to about 15 and the molecular weight is from about 100 to about 300 atomic mass units.

14. The composition of claim 13, further comprising at least one additional compound selected from the group consisting of:
(a) polyoxyalkylene glycol ethers represented by the formula R¹[(OR²)ₙOR³]_{y}, wherein: x is selected from integers from 1 to 3; y is selected from integers from 1 to 4; R1 is selected from hydrogen and aliphatic hydrocarbon radicals having 1 to 6 carbon atoms and y bonding sites; R² is selected from aliphatic hydrocarbylene radicals having from 2 to 4 carbon atoms; R³ is selected from hydrogen, and aliphatic and alicyclic hydrocarbon radicals having from 1 to 6 carbon atoms; at least one of R¹ and R³ is selected from said hydrocarbon radicals; and wherein said polyoxyalkylene glycol ethers have a molecular weight of from about 100 to about 300 atomic mass units and a carbon to oxygen ratio of from about 2.3 to about 5.0;
(b) amides represented by the formulae R¹CONR²R³ and cyclo-[R⁴CON(R⁵)—], wherein R¹, R², R³ and R⁵ are independently selected from aliphatic and alicyclic hydrocarbon radicals having from 1 to 12 carbon atoms; R⁴ is selected from aliphatic hydrocarbylene radicals having from 3 to 12 carbon atoms; and wherein said amides have a molecular weight of from about 120 to about 300 atomic mass units and a carbon to oxygen ratio of from about 7 to about 20,
(c) ketones represented by the formula R¹COR², wherein R¹ and R² are independently selected from aliphatic, alicyclic and aryl hydrocarbon radicals having from 1 to 12 carbon atoms, and wherein said ketones have a molecular weight of from about 70 to about 300 atomic mass units and a carbon to oxygen ratio of from about 4 to about 13,
(d) nitriles represented by the formula R¹CN, wherein R¹ is selected from aliphatic, alicyclic or aryl hydrocarbon radicals having from 5 to 12 carbon atoms, and wherein said nitriles have a molecular weight of from about 90 to about 200 atomic mass units and a carbon to nitrogen ratio of from about 6 to about 12,
(e) chlorocarbons represented by the formula RClₓ, wherein; x is selected from the integers 1 or 2; R is selected from aliphatic and alicyclic hydrocarbon radicals having from 1 to 12 carbon atoms; and wherein said chlorocarbons have a molecular weight of from about 100 to about 200 atomic mass units and carbon to chlorine ratio from about 2 to about 10,
(f) aryl ethers represented by the formula R¹OR², wherein: R¹ is selected from aryl hydrocarbon radicals having from 6 to 12 carbon atoms; R² is selected from aliphatic hydrocarbon radicals having from 1 to 4 carbon atoms; and wherein said aryl ethers have a molecular weight of from about 100 to about 150 atomic mass units and a carbon to oxygen ratio of from about 4 to about 20,
(g) 1,1,1-trifluoroalkanes represented by the formula CF₃R¹, wherein R¹ is selected from aliphatic and alicyclic hydrocarbon radicals having from about 5 to about 15 carbon atoms; and
(h) fluoroethers represented by the formula R¹OCF₂CF₂H, wherein R¹ is selected from aliphatic and alicyclic hydrocarbon radicals having from about 5 to about 15 carbon atoms.

15. The composition of claim 13, further comprising at least one hydrocarbon selected from the group consisting of decanes, undecanes, dodecanes, tridecanes, tetradecanes, pentadecanes and hexadecanes.

16. A method of making the composition of claim 13, 14 or 15, said method comprising contacting the lubricant of claim 13, 14 or 15 in a non-compressor zone of a compression refrigeratin or air conditioning system with said fluorocarbon refrigerant in the presence of an effective amount of said compatibilizer, to form a combination comprising said lubricant, said fluorocarbon, and said compatibilizer.

17. A method of using the composition of claim 16 to return lubricant from a non-compressor zone to a compressor zone in a compression refrigeration or air conditioning system, said method comprising:
(a) transferring said combination from said non-compressor zone to said compressor zone of said refrigeration or air conditioning system.

18. A method of using the composition of claim 9, said method comprising delivering said composition to a compressor refrigeration or air conditioning system to provide miscibility, and/or solubility of a fluorocarbon refrigerant with a refrigeration lubricant. 4.

19. A method for lubricating a compressor in a compression refrigeration or air conditioning system, comprising the step of adding to said compressor the composition of claim 12, 13, or 14.

20. The composition of claim 12, 13 or 14, further comprising an effective amount of a fragrance.
